(19) United States
(12) Patent Application Publication
(10) Pub. No.: US 2003/0213503 A1
(43) Pub. Date: Nov. 20, 2003

(54) Signal-based electrochemical methods for automatic dishwashing

(75) Inventors: Kenneth Nathan Price, Cincinnati, OH (US); William Michael Scheper, Lawrenceburg, IN (US); Mario Elmen Tremblay, West Chester, OH (US); Paul Joseph Drzewiecki, Maineville, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/222,643

(22) Filed: Aug. 16, 2002

Related U.S. Application Data
(60) Provisional application No. 60/381,146, filed on May 17, 2002.
(60) Provisional application No. 60/381,455, filed on May 17, 2002.
(60) Provisional application No. 60/381,472, filed on May 17, 2002.
(60) Provisional application No. 60/381,473, filed on May 17, 2002.

(51) Int. Cl. B08B 7/04

(52) U.S. Cl. 134/18; 134/25.2; 134/26; 134/40; 134/42; 205/744; 510/224

(57) ABSTRACT

Methods of improving tableware cleaning, sanitizing and stain removal using an automatic dishwashing appliance containing an electrochemical cell and/or electrolytic device. The methods comprise steps for generating electrolyzed water by intermittently activating and/or intermittently deactivating the cell so as to sequentially provide a bleaching species at specific times during the wash and/or rinse cycle. Said methods include a signal-sensing system capable of detecting a composition comprising a signal-providing agent, methods of using said compositions, and articles of manufacture.

### CROSS REFERENCE TO RELATED APPLICATIONS

This application claims benefit of the filing date of U.S. Provisional Application Nos. 60,381,146; 60/381,455; 60/381,472; and 60/381,473 all filed May 17, 2002. This application claims reference to U.S. Provisional Application No. 60/280,913, filed Apr. 2, 2001 and U.S. patent application Ser. No. 09/947,846, filed Sep. 6, 2001.

### FIELD OF THE INVENTION

The present invention relates to methods of improving tableware cleaning, sanitizing and stain removal using an automatic dishwashing appliance containing an electrochemical cell and/or electrolytic device. The methods comprise steps for generating electrolyzed water by intermittently activating and/or intermittently deactivating the cell so as to sequentially provide a bleaching species at specific times during the wash and/or rinse cycle. Said methods include a signal-sensing system capable of detecting a composition comprising a signal-providing agent, methods of using said compositions, and articles of manufacture.

### BACKGROUND OF THE INVENTION

Electrochemical cells for use in automatic dishwashing appliances are designed to operate by making use of the water electrolysis process wherein, at the anode-water interface, OH− being present in water due to electrolytic dissociation of water molecules donates an electron to the anode and can be thereby oxidized to oxygen gas which can be removed from the system. As a result, the H+ concentration can be enhanced at the anode-water interface so that H+ enriched acidic water can be produced. In a similar manner, at the cathode-water interface, H+accepts an electron from the cathode and can be reduced to hydrogen to form hydrogen gas which can be similarly eliminated from the system so that the OH− concentration can be increased at the cathode-water interface whereby OH− enriched alkaline water can be generated. Further, when a halogen-containing water (such as, natural water containing sodium chloride or an aqueous solution of sodium chloride) can be subjected to electrolysis, halogenated mixed oxidants are generated in the electrolyzed water.

The following references disclose use of electrochemical cells: U.S. Pat. No. 5,932,171; U.S. Pat. No. 4,481,086; U.S. Pat. No. 4,434,629; U.S. Pat. No. 4,493,760; U.S. Pat. No. 4,402,197; U.S. Pat. No. 5,250,160; U.S. Pat. No. 5,534,120; U.S. Pat. No. 5,865,966; U.S. Pat. No. 5,947,135; JP Application No. 10057297A; JP Application No. 10179489A; JP Application No. 10033448A; JP Patent No. 09122060; JP Patent No. 2000116587; JP Patent No. 10178491; and EP Application No. 0983806A1.

The following references are also related to electrolyzed water: U.S. Pat. No. 3,616,355; U.S. Pat. No. 4,048,047; U.S. Pat. No. 4,062,754; U.S. Pat. No. 4,100,052; U.S. Pat. No. 4,328,084; U.S. Pat. No. 4,761,208; U.S. Pat. No. 5,314,589; U.S. Pat. No. 5,395,492; U.S. Pat. No. 5,439,576; U.S. Pat. No. 5,954,939 (equiv. EP 711,730); and WO 00/34184.

A key advantage of electrolyzed water can be that it can provide improved cleaning, stain removal and sterilization benefits in dish care, largely due to the halogenated mixed oxidants generated. Electrolyzed water, alone or when combined with automatic dishwashing detergent compositions, can be particularly effective in removing a wide range of soils/stains from dishware. This combination will also allow automatic dishwashing detergent compositions to be sold without bleach, while providing the cleaning performance of using a powdered automatic dishwashing detergent composition containing both enzyme and bleach. As a result, enzyme-based liquid-gel automatic dishwashing detergent compositions could become a preferred form wi thin this type of system.

The problem can be that there can be no easy, economical manner to control the production of electrolyzed water in coordination with the cycle times of an automatic dishwasher. The use of electrolyzed water alone will not achieve satisfactory cleaning, sanitizing and stain removal performance. It is simply not enough to simply provide a source of electrolyzed water for use in an automatic dishwashing appliance comprising an electrochemical cell and/or electrolytic device (hereinafter “cell and/or device”). In order for the electrolyzed water keep from interfering with essential cleaning aspects of the appliance (inter alia, enzyme detergency), it can be necessary for the operation of the cell and/or device to be carefully coordinated with the specific parameters associated with the automatic dishwashing cycle and/or process (e.g. water fills, wash subcycles, rinse subcycles, release of detergents and rinse aid compositions, etc).

Accordingly, there can be a clear need in the art for a method for improving tableware cleaning, sanitizing and stain removal by controlling the production of electrolyzed water at specific times in the wash and/or rinse cycle using an automatic dishwashing appliance. The cell and/or device should be capable of being turned on and off at specific times in the wash and/or rinse cycle by some means of control or coordination.

It has surprisingly been found that a ‘customized’ cell and/or device can provide the control and coordination required to provide electrolyzed water at specific times in the wash and/or rinse cycle in an automatic dishwashing appliance. The key can be providing a form of detection and communication between the appliance and the cell and/or device that allows the cell to be turned off and on at specific times during the wash and/or rinse cycles. One solution to the problem can be using a simple timer. For example, the appliance can turn on the cell and/or device ten minutes after the main wash has begun so that the enzymes present in the formula have had that period of time to render their cleaning action before the enzyme-denaturing halogenated mixed oxidants are released.

The following patents disclose the use of electrolyzed water sequencing during treatment generally using mechanical timers: U.S. Pat. No. 5,932,171; U.S. Pat. No. 4,402,197; U.S. Pat. No. 5,250,160; U.S. Pat. No. 5,947,135; JP Application No. 10057297A; JP Application No. 10179489A; JP Application No. 10033448A; JP Patent No. 09122060; JP Patent No. 2000116587; JP Patent No. 10178491; and EP Application No. 0983806A1.

However, to obtain greater precision than using mechanical timers alone, fine-tuned coordination of the introduction of electrolyzed water can be achieved by using a signal-sensing system. With an attached cell and/or device, sensors can be hard-wired into the appliance's own cycle control system to allow for detection and analysis of a host of matrices, including but not limited to, the detergent composition and/or properties of the liquid or gaseous environment of appliance, cell and/or device, and combinations thereof, wherein the signal-sensing system can control the production and/or release of electrolyzed water at a specific time or times during a wash. Thus, unlike timed cycles, the signal-sensing system of the present invention can be capable of generating electrolyzed water in any number of measured responses to changes in the washing and/or rinsing environment according to the properties detected. For example, use an automatic dishwashing composition comprising a chemical trigger, such as a source of alkalinity, could produce a change in pH in the wash and/or rinse water, which then could be immediately detected by the sensor. The sensor would then alert the cell to activate and/or deactivate production of electrolyzed water during the wash and/or rinse cycle. For example, during the rinse cycle, the signal-sensing system could ensure sanitization without the need of the heating element. This system provides real time control and offers distinct advantages over the timer mechanisms of the prior art.

For unattached electrolytic devices comprising electrochemical cells used to generate electrolyzed water in automatic dishwashing appliances, the signal-sensing system of the present invention provides even more surprising and dramatic results. An unattached device does not know when it should start or stop producing electrolyzed water so as to ensure optimal performance and compatibility with the rest of the chemistry happening during the wash and/or cycle of an automatic dishwashing appliance. Like the attached devices, described above, chemical triggers, such as a signal-providing agent, could be used to provide good end-result performance. Nonetheless, the present invention takes this one step further by designing the dishwashing appliance and the unattached electrolytic device as a pair, providing a precise “match” between the appliance's performance cycles and when the device turns on & off to ensure optimum compatibility and performance.

A signal agent and sensing cell can be described in terms of a “lock & key” analogy. The electrochemical cell and/or the electrolytic device can be the lock and the signal chemical can be the key. Not to be limited by theory, this invention can comprise use of an electrochemical cell that can be (a) unattached or attached; (b) recirculating or non-recirculating; (c) disposable or non-disposable and (d) partitioned or non-partitioned, and wherein all of these further include a means for turning the electrochemical cell on and/or off at specific times during the wash cycle. In recirculating method, the appliance will continuously pull wash and/or rinse liquor from the washing basin of the dishwashing appliance basin into the electrochemical cell. A recirculating cell and/or device can also treat both incoming fresh tap water and/or wash/rinse liquor fluid from the appliance basin. Either method preferably includes an indicator (either electrically-based or chemically-based) for communicating to the consumer when it can be time to replace the cell cartridge for disposable cells and/or devices. The chemical-based signal-providing agent can be delivered by a signal-providing detergent composition.

The appliance, electrochemical cell and/or electrolytic device can themselves include a timer, signal-sensing system, sensor, controller, CPU, and combinations thereof, for intermittently activating and turning on the cell at specific time(s) during the wash and/or rinse cycles.

Furthermore, there can be also a long-felt need in the commercial dishwashing industry to eliminate the need for liquid chlorine bleach to be supplied into the final step of an automatic dishwashing process, since liquid chlorine bleach can be often susceptible to serious environmental hazards from spills. The present invention offers a solution to this long-felt need. Methods of using an automatic dishwashing appliance in combination with an electrochemical device which comprises an electrolytic cell capable of being turned on and off at specific times in the wash and/or rinse cycle by a signal-providing agent for treating tableware by providing hypochlorite in situ would allow commercial dishwashers to only need a source of chloride- or chlorite-containing salts to improve tableware cleaning, sanitizing and stain removal.

### SUMMARY OF THE INVENTION

In one aspect of the present invention, a method for cleaning tableware, comprises the steps of sequentially contacting said tableware with an aqueous cleaning liquor comprising a bleach unstable ingredient and an aqueous bleaching liquor comprising the electrolysis products of electrolytes selected from the group consisting of halide anions, halite anions, and mixtures thereof. The automatic dishwashing appliance can comprise an electrochemical cell and means for delivering said aqueous cleaning liquor and said aqueous bleaching liquor to said tableware in a predetermined sequence. The bleach unstable ingredient in said cleaning liquor comprises a detersive enzyme selected from the group consisting of protease, amylase, and mixtures thereof. In the method, the tableware is contacted with said cleaning liquor prior to contact with said bleaching liquor.

In one aspect of the present invention, a method of improved cleaning, sanitizing, and/or stain removal of tableware in an automatic dishwashing appliance can comprise an attached electrochemical cell for producing electrolyzed water, said method comprising the steps of: (a) placing tableware in need of treatment into said appliance; (b) providing at least one attached, signal-sensing electrochemical cell comprising at least one inlet opening and one outlet opening, and at least one pair of electrodes defining a cell chamber comprising a passage formed therebetween through which said aqueous electrolytic solution can flow, wherein said cell and/or appliance further can comprise a signal sensor that can electrically activate and/or deactivate the production of electrolyzed water in said cell; (c) providing an aqueous electrolytic solution in said appliance in fluid communication with said electrochemical cell; (d) providing at least one activator and/or deactivator; (e) intermittently activating said electrochemical cell via said at least one activator at a specific time or times in the wash and/or rinse cycle; (f) electrolyzing said aqueous electrolytic solution in said electrochemical cell to produce at least some electrolyzed water; (g) discharging said electrolyzed water into the wash and/or rinse liquor via a wash basin of said appliance during at least one specific time in the wash and/or rinse cycle(s); (h) interrupting electrolyzation of said aqueous electrolytic solution and/or not releasing said electrolyzed water at other times in the wash and/or rinse cycle(s); (i) contacting said tableware in need of treatment with said electrolyzed water comprising said wash and/or rinse liquor; (j) intermittently deactivating said electrochemical cell via said deactivator during at least one specific time in the wash and/or rinse cycle(s); (k) optionally contacting said tableware with a wash and/or rinse liquor comprising a chlorine-bleach-scavenging agent or metal-protecting agent; and (l) optionally repeating steps (c) through (k) until said tableware are treated.

In another aspect of the present invention, a method of improved cleaning, sanitizing, and/or stain removal of tableware in an automatic dishwashing appliance comprising an unattached electrolytic device for producing electrolyzed water, said method comprising the steps of: (a) placing tableware in need of treatment into said appliance; (b) providing an unattached, signal-sensing electrolytic device comprising at least one electrochemical cell comprising at least one inlet opening and one outlet opening, and at least one pair of electrodes defining a cell chamber comprising a passage formed therebetween through which said aqueous electrolytic solution can flow, wherein said appliance, device and/or cell further comprising a signal sensor that can electrically activate and/or deactivate the production of electrolyzed water in said cell; (c) providing an aqueous electrolytic solution in said appliance in fluid communication with said electrochemical cell; (d) providing at least one activator and/or deactivator; (e) intermittently activating said electrolytic device via said at least one activator at a specific time or times in the wash and/or rinse cycle; (f) electrolyzing said aqueous electrolytic solution in said electrochemical cell to produce at least some electrolyzed water; (g) discharging said electrolyzed water into the wash and/or rinse liquor via a wash basin of said appliance during at least one specific time in the wash and/or rinse cycle(s); (h) interrupting electrolyzation of said aqueous electrolytic solution and/or not releasing said electrolyzed water at other times in the wash and/or rinse cycle(s); (i) contacting said tableware in need of treatment with said electrolyzed water comprising said wash and/or rinse liquor; (j) intermittently deactivating said electrolytic device via said deactivator during at least one specific time in the wash and/or rinse cycle(s); (k) optionally contacting said tableware with a wash and/or rinse liquor comprising a chlorine-bleach-scavenging agent or metal-protecting agent; and (k) optionally repeating steps (c) through (k) until said tableware are treated.

In another aspect of the present invention, a method of improved cleaning, sanitizing, and/or stain removal of tableware in an automatic dishwashing appliance can comprise an electrolytic device, said method using a signal system comprising a signal-providing detergent in conjunction with a signal-sensing device, said method comprising the steps of: (a) placing tableware in need of treatment in said appliance; (b) providing a signal-sensing electrolytic device comprising at least one electrochemical cell at least one inlet opening and one outlet opening, and at least one pair of electrodes defining a cell chamber comprising a passage formed therebetween through which said aqueous electrolytic solution can flow, wherein said appliance, device and/or cell further comprising a signal sensor that can be activated and/or deactivated by a composition comprising at least one signal-providing agent; (c) providing an aqueous electrolytic solution in fluid communication with said electrochemical cell via said electrolytic device; (d) providing at least one activator and/or deactivator in the form of a signal-providing composition comprising at least one signal-providing agent; (e) optionally contacting said signal sensor with said at least one signal-providing composition in order to activate and/or deactivate said at least one electrochemical cell, wherein said activation and/or deactivation starts or stops electrolyzed water production in said signal-sensing electrolytic device; (f) optionally contacting said signal sensor of said signal-sensing electrolytic device with said at least one signal-providing composition in order to activate a timer to delay said electrolyzed water production in said signal-sensing electrochemical cell for a specific time period, wherein after said timed delay said at least one electrochemical cell can be activated; (g) passing said aqueous electrolytic solution through at least one activated electrochemical cell to generate at least some electrolyzed water in the wash and/or rinse liquor of said appliance; (h) contacting said tableware with said at least some electrolyzed water in the wash and/or rinse cycle of said appliance; (i) optionally contacting said signal sensor of said electrolytic device with said composition comprising said at least one signal-providing agent to deactivate said at least one electrochemical cell in order to stop production of said electrolyzed water; (j) optionally contacting said tableware with a wash and/or rinse liquor comprising a chlorine-bleach-scavenging agent or metal-protecting agent; and (k) optionally repeating steps (c) through (j) until the tableware needing treatment are treated.

In yet another aspect of the present invention, an article of manufacture can comprise (a) a component selected from the group consisting of an electrochemical cell refill and/or replacement cartridge, product refill and/or replacement cartridge, filter, elastomeric slit valve, or combinations thereof, (b) information and/or instructions in association with said article comprising the steps describing the use of an electrolytic device, electrochemical cell, electrolytic solution, detergent and/or rinse aid signal-providing composition comprising at least one signal-providing agent, replaceable component, or combinations thereof, in an automatic dishwashing appliance comprising an electrolytic device for treating tableware for improved cleaning, sanitizing, and/or stain removal; (c) optionally, a component selected from the group consisting of suds suppressor, perfume, a chlorine-bleach-scavenging agent, a metal-protecting agent, and mixtures thereof, and mixtures thereof; and (d) optionally, a component selected from the group consisting of an electrolytic composition comprising chloride ions, an electrolytic composition comprising chlorite ions, an electrolytic composition comprising salts having the formula (M)ₓ(XO₂)_{y} and/or (M)ₓ(X)_{y} wherein X can be Cl, Br, or I and wherein M can be a metal ion or cationic entity and wherein x and y are chosen such that the salt can be charge balanced, an electrolysis precursor compound, an electrolysis salt with low water solubility, an electrolysis precursor compound contained within a medium for controlled release, and mixtures thereof, wherein said product optionally housed in a porous basket;

The following description can be provided to enable any person skilled in the art to make and use the invention, and can be provided in the context of a particular application and its requirements. Various modifications to the embodiments will be readily apparent to those skilled in the art, and the generic principles defined herein can be applied to other embodiments and applications without departing from the spirit and scope of the invention. The present invention can be not intended to be limited to the embodiments shown. Thus, since the following specific embodiments of the present invention are intended only to exemplify, but in no way limit, the operation of the present invention, the present invention can be to be accorded the widest scope consistent with the principles, features and teachings disclosed herein.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The various advantages of the present invention will become apparent to those skilled in the art after a study of the foregoing specification and following claims. The following specific embodiments of the present invention are intended to exemplify, but in no way limit, the operation of the present invention. All documents cited are, in relevant part, incorporated herein by reference; the citation of any document can be not to be construed as an admission that it can be prior art with respect to the present invention.

### BRIEF DESCRIPTION OF THE DRAWINGS

The invention will now be explained in detail with reference to the accompanying drawing, in which:

FIG. 1 shows an automatic dishwashing appliance with two electrochemical cells; one capable of electrolyzing tap water alone and the other a recirculating electrochemical cell capable of electrolyzing wash and/or rinse liquor.

FIG. 1a shows a recirculating, electrochemical cell.

FIG. 2 shows an automatic dishwashing appliance with an automatic dishwashing appliance containing an attached, electrochemical cell integrated in the door of the appliance.

FIG. 3 shows an attached, integrated electrolytic device.

FIG. 3a shows the contents of an attached, integrated electrolytic device.

FIG. 4 shows a porous basket comprising product for dispensing.

### DETAILED DESCRIPTION OF THE INVENTION

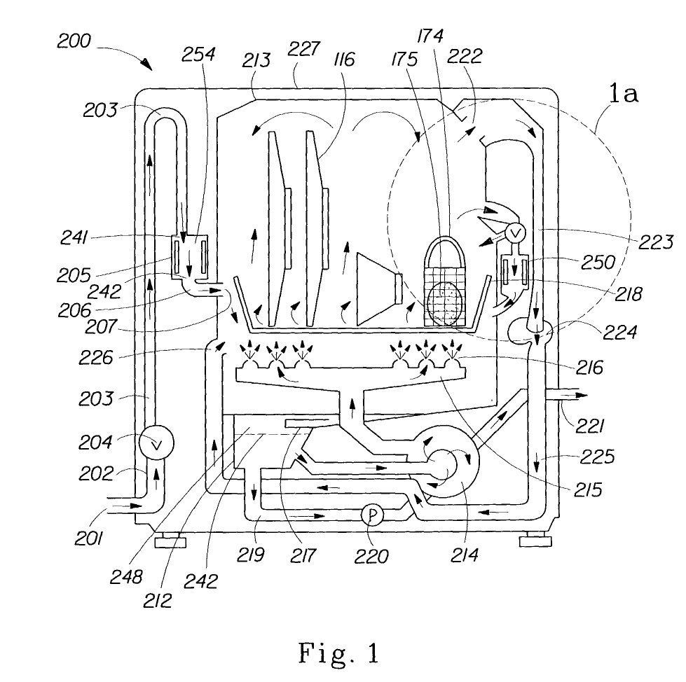

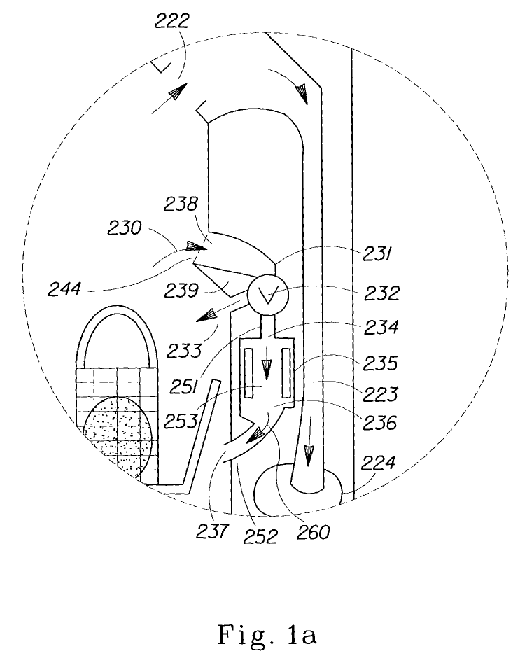

Automatic dishwashing appliance 200 of FIG. 1 and FIG. 1a can be covered with a door (not shown) and a main body cover, 227, and has a washing vessel, 213, therein. A rack, 218, for accommodating tableware to be washed, a rotary washing nozzle, 215, located under rack, 218, and protruding approximately at the center of washing vessel, 213, and a heater, 217, for heating washing water stored in a lower portion of washing vessel, 213, are provided in washing vessel, 213, a plurality of washing water injection openings, 216, are provided on washing nozzle, 215, a recirculated wash and/or rinse liquor collection tray, 239, for collecting recirculated wash and/or rinse liquor, 230, an optional filter, 244, for screening solid leavings, and an inlet port, 238, and an outlet port, 237. In addition, automatic dishwashing appliance, 200, includes, within the automatic dishwashing appliance itself but outside washing vessel, 213, a circulating pump, 214, for supplying washing water stored in washing vessel, 213, to nozzle, 215, a drain pump, 220, for discharging washing water in washing vessel, 213, from a drain pipe, 219, into a drain pipe, 221, and a blower, 224, for sucking air in washing vessel, 213, through an air inlet port, 222, and a sucking duct, 223, and blowing the sucked air into washing vessel, 213, through an air duct, 225, and an air outlet port, 226, to dry the washed tableware.

Automatic dishwashing appliance, 200, further includes, within the automatic dishwashing appliance itself but outside washing vessel, 213, at least one electrochemical cell. The automatic dishwashing appliance can contain electrochemical cell, 205, for producing electrolyzed water, 240, from tap water, 201, water feed pipes, 202 and 203, for externally supplying incoming tap water, 201, to electrochemical cell, 205, a valve, 204, for controlling supply of tap water, 201, to the washing vessel, 213, itself or to the inlet opening, 241, of the electrochemical cell, 205, for electrolysis. The controller (not shown) can provide for periodic cell self-cleaning of the cell, 205, by opening valve, 204, and allowing water to flush the cell passage, 254, and be discharged into the washing basin without applying power for electrolyzation. This self-cleaning can occur periodically throughout the operation of the appliance as needed.

The automatic dishwashing appliance can also contain a recirculating electrochemical cell, 235, for producing electrolyzed, recirculated wash and/or rinse liquor, 260, from recirculated wash and/or rinse liquor, 230, for internally supplying recirculated wash and/or rinse liquor, 230, to recirculating electrochemical cell, 235, a filter, 244, covering the inlet port, 238, of the recirculated wash and/or rinse liquor collection tray, 239, a duct or tube, 231, for directing recirculated wash and/or rinse liquor, 230, to a valve 232, for controlling supply of recirculated wash and/or rinse liquor, 230, to the inlet opening, 234, of the recirculating electrochemical cell, 235, itself or to the bypass outlet, 233, to the washing vessel, 213. An inlet opening, 234, or the recirculating electrochemical cell, 235, a cell passage, 253, formed therebetween from at least one pair of electrodes defining a cell gap for electrolyzing wash and/or rinse liquor, an outlet opening, 236, for connecting recirculating electrochemical cell, 235, with washing vessel, 213, via a duct or pipe, 252, an outlet port, 237, for supplying electrolyzed recirculated wash and/or rinse liquor, 260, from recirculating electrochemical cell, 235, to washing vessel, 213. Note that the automatic dishwashing appliances described herein can contain any combination of electrochemical cells and/or electrolytic devices described herein. Furthermore, self-cleaning of the recirculating cell, 235, can be accomplished by attaching a tap water supply (not shown) to the recirculating cell, 235, via the inlet opening, 234, or by a separate inlet opening (not shown) to allow for periodic flushing of the recirculating cell, 235, with tap water to remove food debris deposited in the cell passage, 253, by the recirculating wash and/or rinse liquors, 230. Similarly, self-cleaning of the recirculating filter, 244, can be accomplished by directing a tap water supply (not shown), such as in the form of a jet (not shown), above or below the filter, 244, to remove food debris deposited during collection of the recirculating wash and/or rinse liquor, 230, by spraying the tap water (not shown) at the filter, 244.

The tableware washing and/or rinsing operation of automatic dishwashing appliance, 200, can be carried out based on the control of the microcomputer (not shown). Since washing and/or rinsing of tableware by automatic dishwashing appliance, 200, can consist of a plurality of washing and/or rinsing steps, such a function as to coordinate the production of a proscribed amount of electrolyzed water, 240 and/or 260, required for each washing and/or rinsing step can be provided by a controller (not shown) having a microcomputer (not shown) for controlling a series of operations by automatic dishwashing appliance, 200.

Note that valves, 204 and 232, are in a closed state in an initial state. When a power supply switch (not shown) of an operation panel (which can be not shown) can be turned on, valve, 204 and/or 232, can be brought into an open state, tap water, 201, supplied from a tap of a water pipe can be supplied through water feed pipe, 202, valve, 204, and water feed pipe, 203, to electrochemical cell, 205, and voltage can be applied to electrochemical cell, 205, or recirculated wash and/or rinse liquor, 230, supplied from a recirculated wash and/or rinse liquor collection tray, 239, filter, 244, inlet port, 238, and tube or duct, 231, to the inlet opening, 234, of recirculating electrochemical cell, 235, and voltage can be applied to recirculating electrochemical cell, 235. Thus, tap water, 201, supplied can be electrolyzed in electrochemical cell, 205, and electrolyzed water, 240, can be produced as a discharge effluent at specific time intervals throughout the wash and/or rinse cycles of the appliance operation. Similarly, recirculated wash and/or rinse liquor, 230, supplied can be electrolyzed in recirculating electrochemical cell, 235, and electrolyzed recirculated wash and/or rinse liquor, 260, can be produced as a discharge effluent at specific time intervals throughout the wash and/or rinse cycles of the appliance operation.

Depending on the need or desired mode selected, the controller (not shown) can optionally provide for the electrolyzation of both the tap water, 201, and the recirculated wash and/or rinse liquor, 230, simultaneously or in sequential combination to produce electrolyzed tap water, 240 and/or electrolyzed recirculated wash and/or rinse liquor, 260, as a discharge effluent during the wash and/or rinse cycle of the automatic dishwashing appliance, 200. In this case, both valves, 204 and 211, can be opened, simultaneously or in sequential combination, allowing both tap water, 201, and recirculated wash and/or rinse liquor, 230, to be electrolyzed.

Note that if un-electrolyzed tap water, 201, alone can be required during the wash and/or rinse cycle, the controller (not shown) will open valve, 204, to supply tap water, 201, to feed pipe, 243, which directly opens into washing vessel, 213, to provide washing water, 248. In this case, no electrolyzed water can be present in the washing water, 248, since the tap water, 201, bypasses the electrochemical cell, 205. Note that valve, 204, can be opened such as to provide tap water, 201, to both feed pipes, 203 and 243, simultaneously, to allow for partial electrolyzation of at least some the incoming tap water, 201.

Electrolyzed tap water, 240 and/or electrolyzed recirculated wash and/or rinse liquor, 260, produced by application of voltage to electrochemical cell, 205 and/or recirculating electrochemical cell, 235, can be directed from outlet port, 207 and/or 237, into washing vessel, 213, by inflow pressure of tap water, 201, by mass transport, by pump (not shown), and/or by gravity feed. For sanitization purposes heater, 217, can not be required to be turned on during the wash and/or rinse cycle, due to the halogenated mixed oxidants present in the washing water, 248, comprising electrolyzed tap water, 240 and/or electrolyzed recirculated wash and/or rinse liquor, 260. For other purposes such as cleaning and stain removal, the heater, 217, can be optionally turned on to heat the washing water, 248, in response to the controller (not shown), timer (not shown) and/or sensor (not shown) detecting a change in the fluid or gaseous environment within automatic dishwashing appliance, 200, or the electrochemical cell, 205 and/or 235. With the detection of a specified stimulus, such as a proscribed water level or pH level of the washing water, 248, the circulating pump, 214, can be operated while the washing water, 248, optionally comprising electrolyzed tap water, 240 and/or electrolyzed recirculated wash and/or rinse liquor, 260, can be heated to a proscribed temperature. Note that detection of the water level of washing water, 248, in washing vessel, 213, can be carried out by provision of a float switch type water level sensor (not shown), by the controller (not shown) and/or by water supply time measured with a timer (not shown). Note that a turbidity sensor, water hardness sensor, pH sensor, conductivity sensor, and combinations thereof (not shown), can be used to detect a change in the fluid, the gaseous environment within automatic dishwashing appliance, 200, the electrochemical cell, 205 and/or 235, and/or the electrolytic device (not shown).

Tap water, 201, containing electrolyzed water, 240, and/or recirculated wash and/or rinse liquor, 230, containing electrolyzed wash and/or rinse liquor, 260, can be injected with rotation from injection openings, 216, through washing nozzle, 215, whereby tableware placed in rack, 1218, can be treated with electrolyzed tap water, 240, and/or electrolyzed recirculated wash and/or rinse liquor, 260, at specific intervals during the wash and/or rinse cycles of the automatic dishwashing appliance, 200. When washing and/or rinsing for proscribed time can be completed, circulating pump, 214, can be stopped. Then, drain pump, 220, can be operated, and wash and/or rinse liquor, 230, containing used electrolyzed tap water, 240, and/or electrolyzed recirculated wash and/or rinse liquor, 260, can be discharged from drain pipe, 221, through drain pipe, 219, and drain pump, 220. When discharging of the wash and/or rinse liquor, 230, can be completed, drain pump, 220, can be deactivated.

During a second and/or subsequent wash and/or rinse cycle, valve, 204, can optionally be brought into an open state, allowing tap water, 201, to flow through feed pipe, 243, to washing vessel, 213, filling washing basin, 212, to a proscribed level. Valve, 204, can then be brought into a closed state. Note that valve, 204, can be opened for a specific amount of time and then closed to induce self-cleaning of the recirculating cell as described above, at any time during the operation of the appliance. The application of power to the cell can be not necessary during the cell self-cleaning process.

Valve, 232, can simultaneously and/or in sequential combination with the operation of valve, 204, be optionally brought into an open state, recirculated wash and/or rinse liquor, 230, collected by the recirculated wash and/or rinse liquor collection tray, 239, passing through the filter, 244, inlet port, 238, duct or tube, 231, feed pipe, 208, into the cell passage, 253, through inlet opening, 234, of recirculating electrochemical cell, 235, and voltage can be applied to electrochemical cell, 205, wherein electrolyzed recirculated wash and/or rinse liquor, 260, can be produced and discharged from the outlet opening, 236, the duct or tube, 260, the outlet port, 237, into the washing vessel, 213, and collected in the washing basin, 212, for additional recirculation.

Subsequent washing and/or rinsing steps can be carried out in a manner similar to that of the first one. Thus, the number of steps required can be carried out, whereby washing and/or rinsing can be completed. To put drying after the completion of washing and/or rinsing step briefly, blower, 224, can be first operated, and air in washing vessel, 213, can be sucked from air inlet port, 222, through sucking duct, 223, and directed through blower, 224, air duct, 225, and air outlet port, 226, into washing vessel, 213, to absorb heat energy of heater, 217, while circulating in washing vessel, 213, for proscribed time, whereby drying of the tableware can be completed.

Thus, in automatic dishwashing appliance, 200, of FIG. 1 and FIG. 1a, while electrolyzed tap water, 240, can be produced by electrochemical cell, 205, electrolyzed tap water, 240, will not be discarded being unused, and water can be saved. This can be especially true for electrolyzed recirculated wash and/or rinse liquor, 260. The water-saving benefit occurs when recirculated wash and/or rinse liquor, 230, can be used as the aqueous electrolytic solution. In this case, an increase in the activity of halogenated mixed oxidants can be delivered to the recirculating wash and/or rinse liquor during the wash and/or rinse cycle of the automatic dishwashing appliance, 200. Water can be saved by recirculating the existing wash and/or rinse liquor, 230, through the recirculating electrochemical cell, 235, without having to add additional electrolyzed tap water, 240. Recirculation also promotes the benefits of cleaning, sanitizing, and stain removal by preventing excessive dilution of the wash and/or rinse liquor, 230, during operation of the automatic dishwashing appliance, 200. Because the heater, 217, can be not required for sanitization purposes, automatic dishwashing appliance, 200, achieves energy-savings by reducing the total energy consumption less than about 1.8 kWh per operating cycle or about 600 kWh per year, preferably less than about 1.7 kWh per operating cycle or about 555 kWh per year, most preferably can be less than about 1.2 kWh per operating cycle or about 400 kWh per year.

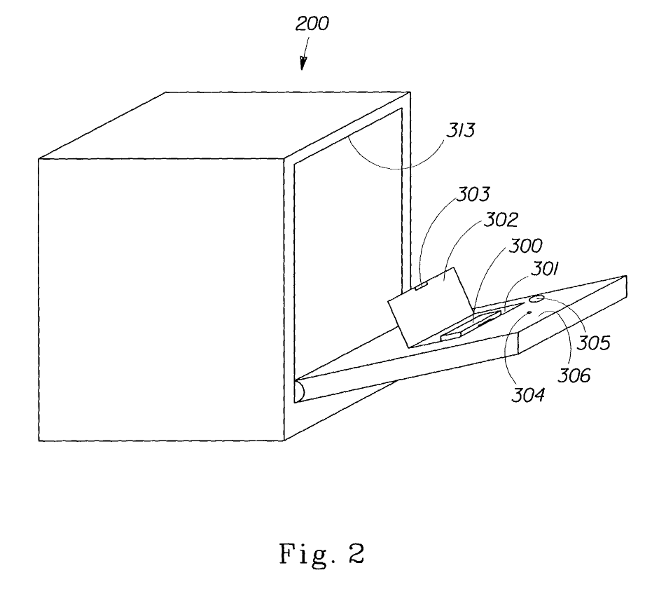

FIG. 2 depicts an automatic dishwashing appliance, 200, having an automatic dishwashing appliance containing a device, 300, located in a sealed or sealable compartment, 301, with a sealable cover, 302, and cover latch, 303, in the door, 306, of the automatic dishwashing appliance, 200. The electrolytic device, 300, can be electronically connected to a replacement indicator, 304, located on the interior surface of the door, 306, which can alert the consumer to the need to replace the electrolytic device, 300, itself and/or a disposable electrolytic component (not shown) within cell and/or device, 300. For simplicity, the electrochemical cell can be not shown. The appliance, 200, and/or the electrolytic device, 300, can comprise a sensor (not shown) to detect and/or analyze the composition and/or properties of the liquid or gaseous environment within said signal-sensing cell and/or device, 300, the appliance, 200, and combinations thereof.

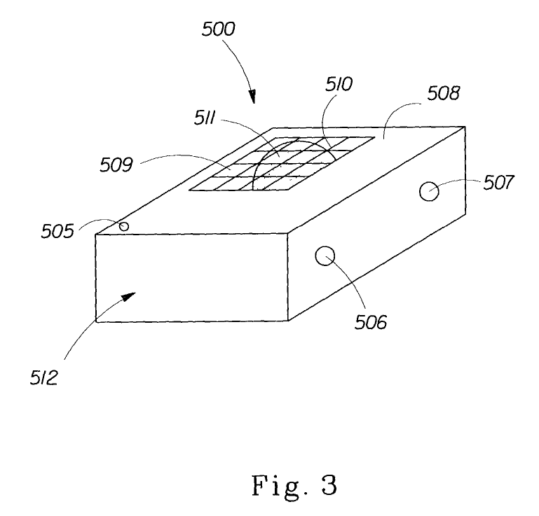

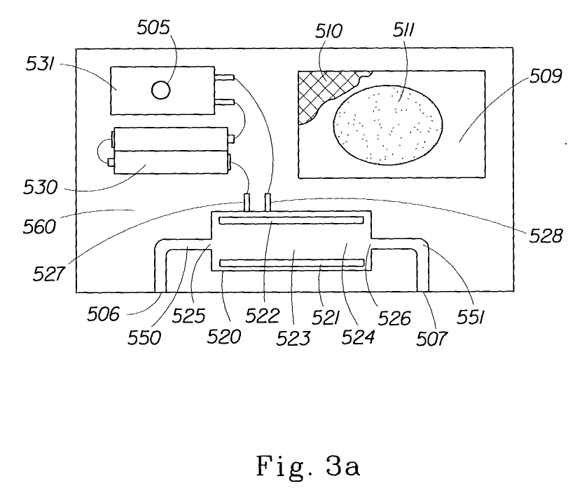

FIG. 3 and FIG. 3a depict another embodiment of the present invention. The electrolytic device, 500, can be located on any interior surface of the washing vessel, 213, of the automatic dishwashing appliance (not shown) itself. The electrolytic device, 500, respectively, having a body, 512, with a substantially continuous outer surface, 508. The body, 512, comprising an inlet port, 506, which can be covered by a detachable filter or screen (not shown), to minimize fouling of the electrochemical cell, due to the large debris load during the collection of electrolytic solution in the wash and/or rinse cycle of the automatic dishwashing appliance, an outlet port, 507, for discharge of the electrolyzed water to the washing vessel (not shown). The body, 512, can optionally comprise at least one additional compartment, 509. The compartment, 509, can house a product or local source of halogen ions, 511, which dissolves slowly (e.g. over months) when exposed to the wash and/or rinse liquor (not shown). The compartment, 509, comprising an easily removable and replaceable plastic screen, 510, which helps to contain the product, 511, in the compartment, 509, and also allows for fluid communication between the product, 511, and the wash and/or rinse liquor (not shown) during operation of the appliance (not shown). When the product, 511, can be completely dissolved, the consumer can add a product refill by removing the plastic screen, 510, and inserting a new product, 511, or refill in the compartment, 509, and then closing the screen, 510, to contain the new product, 511.

The electrochemical cell, 520, can be in fluid communication with the aqueous electrolytic solution, comprising the wash and/or rinse liquors from the appliance, via the inlet port, 506, of the body, 512. The inlet port, 506, can be outwardly connected to a funnel or water collection tray (not shown) to allow electrolytic solution comprising wash liquor, rinse liquor, tap water, and mixtures thereof, to be directed to an electrochemical cell, 520. The inlet port, 506, can be inwardly connected to a tube or duct, 550, which can be connected to an electrochemical cell, 520, having an inlet opening, 525, an anode electrode, 521, a cathode electrode, 522, defining a cell gap comprising a cell passage, 523, formed therebetween through which the aqueous electrolytic solution can flow, an outlet opening, 526, connected to a tube or duct, 551, which can be connected to the outlet port, 507, to allow the electrolyzed water (not shown) to discharge into the washing vessel (not shown) of the automatic dishwashing appliance (not shown).

The automatic dishwashing appliance can comprise a source of electrical current supply (not shown), which can be integrated into appliance itself. Besides having a source of electrical current supply (not shown), the attached, integrated electrochemical cell, 520, and/or electrolytic device, 300, can optionally have a supplemental battery, 530, which can provide the current used by the electrochemical cell, 520, to the anode lead, 527, and the cathode lead, 528, of the electrochemical cell, 520, to generate electrolyzed water in the cell passage, 524. The electrochemical cell, 520, can be optionally electrically and/or electronically connected to a controller, 531, which can comprise an on-off switch (not shown), a timer (not shown), a sensor (not shown) to detect and/or analyze the composition and/or properties of the liquid or gaseous environment within said signal-sensing cell and/or device, 500, the appliance (not shown), and combinations thereof, and an indicator lamp, 505, that indicates to the consumer the status of the appliance, the cell and/or the device during operation. The indicator can shown the consumer that the electrolytic device, 500, the cell, 520, and/or the batteries, 530, need to be replaced. The cathode lead, 552, can be connected to the controller, 531, which can be connected to the positive lead of the battery, 530, to the anode lead, 553, connected to the negative lead of the battery, 530.

The water collected by the inlet port, 506, can flow by gravity and/or by pump through the electrochemical cell, 520, and out the outlet port, 507, via a tube or duct, 551. The release or discharge of at least some electrolyzed water (not shown) as a discharge effluent via the outlet opening, 526, of the electrochemical cell, 520, itself and/or the outlet port, 507, of the electrolytic device, 500, into the appliance (not shown) can occur at specific timed intervals or continuously during operation of the wash and/or rinse cycles.

During operation, the electrochemical cell, 520, positioned inside the body, 512, can be placed into fluid communication with the aqueous electrolytic solution (not shown) of the automatic dishwashing appliance (not shown) comprising tap water, wash and/or rinse liquor, and mixtures thereof (not shown), via at least one inlet port, 506. The inlet port, 506, can be connected to a tube or duct, 550, that connects to the inlet opening, 525, of the electrochemical cell, 520. Likewise, the body, 512, can have an outlet port, 507, that can be in fluid communication between the outlet opening, 526, and with the wash and/or rinse liquor (not shown) of the automatic dishwashing appliance (not shown) via a tube or duct, 551.

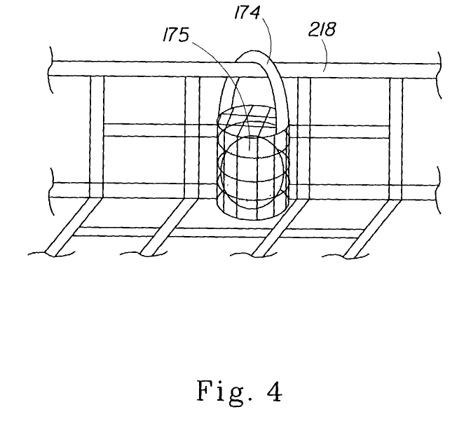

FIG. 4 depicts a porous basket, 174, for dispensing a product, 175, which can be placed in rack, 218, of any automatic dishwashing appliance of the present invention to deliver the product to the washing water of the appliance over time by slowly dissolving with each wash and/or rinse cycle. The product can comprise a signal-providing detergent composition, signal-providing agent, and combinations thereof.

Although the present invention has been described and illustrated in detail, it can be clearly understood that the same can be by way of illustration and example only and can be not to be taken by way of limitation, the spirit and scope of the present invention being limited only by the terms of the appended claims.

Sensors

A “chemical sensor” can be a device for detecting the presence or concentration of an analyte. One example of a chemical sensor features one or more supports, such as beads, which carry a thin film of polymer substrate. The polymer substrate has a sensing reagent and a porous matrix. The sensing reagent alters the optical properties of the polymer substrate in the presence of analyte.

Chemical sensors for detecting analytes in fluids comprise first and second conductive elements (e.g., electrical leads) electrically coupled to and separated by a chemically sensitive resistor that provides an electrical path between the conductive elements. The resistor can comprise a plurality of alternating nonconductive regions (comprising a nonconductive organic polymer) and conductive regions (comprising a conductive material) transverse to the electrical path. The resistor provides a difference in resistance between the conductive elements when contacted with a fluid comprising a chemical analyte at a first concentration, than when contacted with a fluid comprising the chemical analyte at a second different concentration. Arrays of such sensors are constructed with at least about two sensors having different chemically sensitive resistors providing dissimilar such differences in resistance. Variability in chemical sensitivity from sensor to sensor can be provided by qualitatively or quantitatively varying the composition of the conductive and/or nonconductive regions. An electronic nose for detecting an analyte in a fluid can be constructed by using such arrays in conjunction with an electrical measuring device electrically connected to the conductive elements of each sensor.

A fluorescence energy transfer indicator can also be used, in conjunction with a chemical sensor incorporating it. The fluorescence energy transfer indicator includes a rigid spacer group that tethers together a fluorescent energy donor and a calorimetric indicator acceptor, the tethering being across a predetermined, known or determinable length in order to thereby tailor the indicator to the specific needs of the chemical sensor. The emission spectrum of the fluorescent energy donor overlaps with an absorbance spectrum of the calorimetric indicator acceptor, which undergoes a change in color or in color intensity as a function of the species being monitored or measured in accordance with parameters of the species such as pH, oxygen concentration, carbon dioxide concentration and the like.

Optical chemical probes can be used for chemical analysis. The optical chemical probes have layers of anionic and cationic polyelectrolytes and one or more dyes incorporated into these layers. The probes are placed into the medium and the dye or dyes react in the presence of the corresponding chemical. Color changes can be observed manually or by a photo detector. A light source can be employed to increase the optical signal received from the probe. Further, a waveguide can be used to trap multiple optical signals.

A chemical sensor for detecting a chemical species in a gas can be used which can comprise a detector element including a porous organic semiconductor comprised of a material on which the chemical species in the gas can be adsorbed. The chemical sensor further can comprise a power source for producing a bias voltage and a depletion region in the detector element. The chemical species percolates through the organic semiconductor and into the depletion region under the bias voltage, causing a change in the capacitance of the detector element. A light source irradiates the gas with light before entering the detector element. The light changes the chemical properties of the chemical species and enhances the adsorption selectivity of the organic semiconductor. The chemical sensor can determine both the presence and concentration of the chemical species in the gas based on the change in capacitance in the detector element. The chemical sensor can be provided in a portable unit suitable for self-contained applications.

At specific time intervals throughout the wash and/or rinse cycles of an automatic dishwashing appliance comprising an electrochemical cell and/or electrolytic device, the signalsensing system can activate and/or deactivate the signal-sensing cell and/or device using at least one sensor capable of analyzing or detecting the composition of the fluid or gaseous environment of the electrochemical cell and/or device or within the appliance. The sensor can be capable of detecting volatile compounds or gases selected from the group consisting of perfumes, perfume raw materials, volatile organic compounds, gases comprising oxides of carbon, sulfur, or nitrogen, and mixtures thereof. The sensor can also be capable of signaling the cell and/or device electrically, electronically, chemically and/or mechanically in order to activate and/or deactivate the operation of the cell and/or corresponding production of halogenated mixed oxidants. When an electric signal can be sent from the sensor, the signal-sensing cell and/or device will activate and/or deactivate the production of halogenated mixed oxidants. The operation of the cell and/or device can be activated or deactivated at any specific time during the operation of the appliance by the signal-sensing system, such as during a specific cycle, or for any other need identified by the consumer.

The following U.S. Patents disclose sensors, sensing devices and methods of use which can be used in conjunction with the present application by one skilled in the art: U.S. Pat. No. 5,037,615, U.S. Pat. No. 5,308,771, U.S. Pat. No. 6,051,437, U.S. Pat. No. 6,077,712, and U.S. Pat. No. 6,331,244.

Signal-Prividing Detergent Composition

The signal-providing detergent composition of the present invention can include, but can comprise, but is not limited to, the following signal-providing chemicals and agents:

(a) Halogenated Salt

The present invention can comprise one or more halogenated salts selected from the group consisting of halite salt, halide salt, and mixtures thereof. The level of halogenated salt comprised in the wash and/or rinse liquor can be selected based on the required bleaching or disinfection required by the halogenated mixed oxidants, in addition to the conversion efficiency of the electrochemical cell to convert the halogenated salt to the halogenated mixed oxidants. The level of halogenated salt can be generally from about 1 ppm to about 10,000 ppm. For disinfection of wash and/or rinse liquor, a halogenated salt level can be preferably from about 1 ppm to about 5000 ppm, and more preferably about 10 ppm to about 1000 ppm. The resulting halogenated mixed-oxidant level can be from about 0.1 ppm to about 10,000 ppm, preferably from about 1 ppm to about 200 ppm. For bleaching purposes, a halogenated salt level of from about 100 ppm to about 10,000 ppm can be preferred.

The range of halogenated mixed oxidants conversion that can be achievable in the electrochemical cells of the present invention generally ranges from less than about 1% to about 99%. The level of conversion can be dependent most significantly on the design of the electrochemical cell, herein described, as well as on the electrical current properties used in the electrochemical cell.

In certain circumstances, halogenated salts of calcium and magnesium having a reduced solubility in water, as compared to sodium halogenated salts, control the rate of dissolution of the halogenated salt. The signal-providing composition can also be formulated with other organic and inorganic materials to control the rate of dissolution of the halogenated salt. Preferred can be a slow dissolving salt particle and/or tablet, to release sufficient halogenated salt to form an effective amount of halogenated precursor product. The release amount of the halogenated salt can be typically, between 1 milligram to 10 grams halogenated salt, for each liter of solution passed through the electrochemical cell. The signal-providing composition can comprise a simple admixture of the halogenated salt with the dissolution control materials, which can be selected from various well-known encapsulating materials, including but not limited to fatty alcohol, fatty acids, and waxes.

The signal-providing composition of the present invention can comprise a local source of halogenated salt, and a means for delivering the halogenated salt to the wash and/or rinse liquor. This embodiment can be advantageously used in those situations when the target water to be treated with the electrochemical cell does not contain a sufficient amount, or any, of the halogenated salt. The local source of halogenated salt can be released into a stream of the aqueous solution, which then ultimately passes through the electrochemical cell. The local source of halogenated salt can also be released into at least some of the wash and/or rinse liquor present in the washing basin of the automatic dishwashing appliance, which portion can be then drawn into the electrochemical cell. Preferably, in order to maximize the conversion to halogenated mixed oxidants, and limit the addition of salts to the wash and/or rinse liquor, generally all the local source of halogenated salt passes through the electrochemical cell. The local source of halogenated salt can also supplement any residual levels of halogenated salt already contained in incoming tap water and/or the wash and/or rinse liquor.

The local source of halogen ions can be from a signal-providing detergent and/or rinse aid composition, a concentrated brine solution, a halogenated salt tablet, granule, or pellet in fluid contact with the aqueous electrolytic solution, or in a porous basket hanging on the rack of the automatic dishwashing appliance, or both. A preferred localized source of halogen ions can be a solid form, such as a pill or tablet, of halide salt, such as sodium chloride (common salt) or sodium chlorite. The means for delivering the local source of halogen ions can comprise a salt chamber or a porous basket comprising the halogenated salt, preferably a pill of tablet, through which at least some of the aqueous electrolytic solution will pass, thereby dissolving at least some of the halide salt into the portion of water. The salted portion of water then ultimately passes into the electrochemical cell. The salt chamber or a porous basket can comprise a salt void that can be formed in the body and positioned in fluid communication with the portion of water that will pass through the electrochemical cell.

One embodiment of the present invention relates to a signal-providing composition, wherein the halogenated salt can be in a form selected from the group characterized by low water solubility, contained within a medium for controlled release, and combinations thereof.

Another embodiment of the present invention relates to a signal-providing composition, wherein the controlled release form provides a local source of the halogenated salt comprising a form such that once placed inside a dishwashing appliance it provides a controlled release of steady levels of halogen dioxide salts into the wash and/or rinse liquors during operation of an automatic dishwasher over a period of from 1 day to 365 days of regular household and/or commercial use.

(i) Halogen Dioxide Salt—The precursor material from which halogen dioxide can be formed can be referred to as a halogen dioxide salt. The halogen dioxide salt of the present invention having the formula (M)ₓ(XO₂)_{y}, wherein X can be Cl, Br, or I and wherein M can be a metal ion or cationic entity, and wherein x and y are chosen such that the salt can be charge balanced. The halogen dioxide salt can comprise two or more salts in various mixtures.

The most preferred halite salt can be sodium chlorite. Sodium chlorite can be not a salt ordinarily found in tap water, well water, and other water sources. Consequently, an amount of the sodium chlorite salt can be added into the wash and/or rinse liquor at a desired concentration generally of at least about 0.1 ppm.

The wash and/or rinse liquor can comprise substantially no chloride (Cl³¹ ) or other halide ions, which upon electrolysis can form a mixed oxidant, including hypochlorite. Preferably, electrolyzed discharge effluent can comprise less than about 1.0 ppm, and more preferably less than about 0.1 ppm, of chlorine. The wash and/or rinse liquor comprising the sodium chlorite can be provided in a variety of ways.

One embodiment of the present invention relates to a signal-providing composition comprising sodium chlorite, preferably, a concentrated solution about 2% to about 35% sodium chlorite by weight of the composition in the form of a liquid and/or gel.

One embodiment of the present invention relates to an automatic dishwashing composition for treating tableware in an automatic dishwashing appliance comprising an electrochemical cell and/or electrolytic device for improved tableware cleaning, sanitizing, and/or stain removal, the composition comprising: (a) a halogen dioxide salt having the formula (M)ₓ(XO₂)_{y}, wherein X can be Cl, Br, or I and wherein M can be a metal ion or cationic entity, and wherein x and y are chosen such that the salt can be charge balanced; and (b) a component selected from the group consisting of a builder, suds suppressor, perfume, a bleach-scavenging agent, a metal-protecting agent, and mixtures thereof; wherein the composition can be optionally free of bleach.

Another embodiment of the present invention relates to a signal-providing composition, wherein the halogenated salt can comprise a salt selected from the group consisting of NaClO₂, KClO₂, and mixtures thereof. Another embodiment of the present invention relates to a signal-providing composition, wherein NaClO₂, KClO₂, and mixtures thereof, can be present at a level of greater than about 0.1%, preferably at a level greater than about 0.5%, more preferably at a level of greater than about 1% by weight of the composition, most preferably at a level of greater than about 2%, by weight of the composition.

(ii) Other Halogenated Salts—In substitution of and/or addition to halogen dioxide salt, the present invention can comprise one or more halide salts. The halide salt of the present invention having the formula (M)ₓ(X)_{y} wherein X can be Cl, Br, or I and wherein M can be a metal ion or cationic entity, and wherein x and y are chosen such that the salt can be charge balanced, can be used to enhance the disinfection and bleaching performance of the effluent that can be discharged from the electrochemical cell, or to provide other halogenated mixed oxidants, when preferred, in response to the passing of electrical current through the electrochemical cell.

One embodiment of the present invention relates to an automatic dishwashing composition for treating tableware in an automatic dishwashing appliance comprising an electrochemical cell and/or electrolytic device for improved tableware cleaning, sanitizing, and/or stain removal, the composition comprising: (a) at least about 0.1%, by weight of the composition, of a halogenated salt having the formula (M)ₓ(X)_{y}, wherein X can be Cl, Br, or I and wherein M can be a metal ion or cationic entity, and wherein x and y are chosen such that the salt can be charge balanced; and (b) a component selected from the group consisting of a builder, suds suppressor, perfume, a bleach-scavenging agent, a metal-protecting agent, enzymes, and mixtures thereof; wherein the composition can be optionally free of bleach.

Another embodiment of the present invention relates to a signal-providing composition comprising NaCl, KCl, and mixtures thereof, at a level of greater than about 0.1%, preferably at a level greater than about 0.5% by weight of the composition, more preferably at a level of greater than about 1% by weight of the composition most preferably at a level of greater than about 2%, by weight of the composition.

(b) Builders

Detergent builders are included in the compositions herein to assist in controlling mineral hardness and dispersancy. Inorganic as well as organic builders can be used. Builders are typically used in automatic dishwashing, for example to assist in the removal of particulate soils. The level of builder can vary widely depending upon the end use of the composition and its desired physical form. When present, the compositions will typically comprise at least about 1% builder. Liquid formulations typically comprise from about 5% to about 50%, more typically about 5% to about 30%, by weight, of detergent builder. Lower or higher levels of builder, however, are not meant to be excluded.

One embodiment of the present invention relates to a signal-providing composition, wherein the builder can be selected from the group consisting of phosphate, phosphate oligomers or polymers and salts thereof, silicate oligomers or polymers and salts thereof, aluminosilicates, magnesioaluminosiliates, citrate, and mixtures thereof.

(i) Phosphate Builders—Phosphate detergent builders for use in detergent compositions are well known. They include, but are not limited to, the alkali metal, ammonium and alkanolammonium salts of polyphosphates (exemplified by the tripolyphosphates, pyrophosphates, and glassy polymeric meta-phosphates). Phosphate builder sources are described in detail in Kirk Othmer, 3rd Edition, Vol. 17, pp. 426-472 and in “Advanced Inorganic Chemistry” by Cotton and Wilkinson, pp. 394-400 (John Wiley and Sons, Inc.; 1972).

Inorganic or non-phosphate P-containing detergent builders include, but are not limited to, phosphonates, phytic acid, silicates, carbonates (including bicarbonates and sesquicarbonates), sulfates, citrate, zeolite or layered silicate, and aluminosilicates. See U.S. Pat. No. 4,605,509 for examples of preferred aluminosilicates.

(ii) Silicate Builders—The present automatic dishwashing detergent compositions can further comprise water-soluble silicates. Water-soluble silicates herein are any silicates, which are soluble to the extent that they do not adversely affect spotting/filming characteristics of the signal-providing composition.

Examples of silicates are sodium metasilicate and, more generally, the alkali metal silicates, particularly those having a SiO₂:Na₂O ratio in the range 1.6:1 to 3.2:1; and layered silicates, such as the layered sodium silicates described in U.S. Pat. No. 4,664,839, issued can 12, 1987 to H. P. Rieck. NaSKS-6® can be a crystalline layered silicate marketed by Hoechst (commonly abbreviated herein as “SKS-6”). Unlike zeolite builders, Na SKS-6 and other watersoluble silicates useful herein do not contain aluminum. NaSKS-6 can be the δ-Na₂SiO₅ form of layered silicate and can be prepared by methods such as those described in German DE-A-3,417,649 and DE-A-3,742,043. SKS-6 can be a preferred layered silicate for use herein, but other such layered silicates, such as those having the general formula NaMSixO₂ₓ₊₁.yH₂O wherein M can be sodium or hydrogen, x can be a number from 1.9 to 4, preferably 2, and y can be a number from 0 to 20, preferably 0 can be used. Various other layered silicates from Hoechst include NaSKS-5, NaSKS-7 and NaSKS-11, as the α-, β- and γ-forms. Other silicates can also be useful, such as for example magnesium silicate, which can serve as a crispening agent in granular formulations, as a stabilizing agent for oxygen bleaches, and as a component of suds control systems.

Silicates particularly useful in automatic dishwashing (ADD) applications include granular hydrous 2-ratio silicates such as BRITESIL® H₂O from PQ Corp., and the commonly sourced BRITESIL® H24 though liquid grades of various silicates can be used when the signal-providing composition has liquid form. Within safe limits, sodium metasilicate or sodium hydroxide alone or in combination with other silicates can be used in a signal-providing context to boost wash pH to a desired level.

Aluminosilicate builders can be used in the present compositions though are not preferred for automatic dishwashing detergents. Aluminosilicate builders are of great importance in most currently marketed heavy duty granular detergent compositions, and can also be a significant builder ingredient in liquid detergent formulations. Aluminosilicate builders include those having the empirical formula: Na₂O.Al₂O₃.xSiO_{z}.yH₂O wherein z and y are integers of at least about 6, the molar ratio of z to y can be in the range from 1.0 to about 0.5, and x can be an integer from about 15 to about 264.

Useful aluminosilicate ion exchange materials are commercially available. These aluminosilicates can be crystalline or amorphous in structure and can be naturally-occurring aluminosilicates or synthetically derived. A method for producing aluminosilicate ion exchange materials can be disclosed in U.S. Pat. No. 3,985,669, Krummel, et al, issued Oct. 12, 1976. Preferred synthetic crystalline aluminosilicate ion exchange materials useful herein are available under the designations Zeolite A, Zeolite P (B), Zeolite MAP and Zeolite X. In another embodiment, the crystalline aluminosilicate ion exchange material has the formula: Na₁₂[(AlO₂)₁₂(SiO₂)₁₂].xH₂O wherein x can be from about 20 to about 30, especially about 27. This material can be known as Zeolite A. Dehydrated zeolites (x=0−10) can also be used herein. Preferably, the aluminosilicate has a particle size of about 0.1-10 microns in diameter. Individual particles can desirably be even smaller than 0.1 micron to further assist kinetics of exchange through maximization of surface area. High surface area also increases utility of aluminosilicates as adsorbents for surfactants, especially in granular compositions. Aggregates of silicate or aluminosilicate particles can be useful, a single aggregate having dimensions tailored to minimize segregation in granular compositions, while the aggregate particle remains dispersible to submicron individual particles during the wash. As with other builders such as carbonates, it can be desirable to use zeolites in any physical or morphological form adapted to promote surfactant carrier function, and appropriate particle sizes can be freely selected by the formulator.

(iii) Carbonate Builders—Examples of carbonate builders are the alkaline earth and alkali metal carbonates as disclosed in German Patent Application No. 2,321,001 published on Nov. 15, 1973. Various grades and types of sodium carbonate and sodium sesquicarbonate can be used, certain of which are particularly useful as carriers for other ingredients, especially detersive surfactants.

(iv) Organic Detergent Builders—Organic detergent builders suitable for the purposes of the present invention include, but are not restricted to, a wide variety of polycarboxylate compounds. As used herein, “polycarboxylate” refers to compounds having a plurality of carboxylate groups, preferably at least about 3 carboxylates. Polycarboxylate builder can generally be added to the composition in acid form, but can also be added in the form of a neutralized salt or “overbased”. When utilized in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate, as disclosed in Berg, U.S. Pat. No. 3,128,287, issued Apr. 7, 1964, and Lamberti et al, U.S. Pat. No. 3,635,830, issued Jan. 18, 1972. See also “TMS/TDS” builders of U.S. Pat. No. 4,663,071, issued to Bush et al, on can 5, 1987. Suitable ether polycarboxylates also include cyclic compounds, particularly alicyclic compounds, such as those described in U.S. Pat. Nos. 3,923,679; 3,835,163; 4,158,635; 4,120,874 and 4,102,903.

(v) Other Useful Builders—Other useful detergency builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediaminetetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty laundry detergent and automatic dishwashing formulations due to their availability from renewable resources and their biodegradability. Citrates can also be used in combination with zeolite, the aforementioned BRITESIL types, and/or layered silicate builders. Oxydisuccinates are also useful in such compositions and combinations.

Also suitable in the detergent compositions of the present invention are the 3,3dicarboxy-4-oxa-1,6-hexanedionates and the related compounds disclosed in U.S. Pat. No. 4,566,984, Bush, issued Jan. 28, 1986. Useful succinic acid builders include the C₅-C₂₀ alkyl and alkenyl succinic acids and salts thereof. A particularly preferred compound of this type can be dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in European Patent Application 86200690.5/0,200,263, published Nov. 5, 1986.

Other suitable polycarboxylates are disclosed in U.S. Pat. No. 4,144,226, Crutchfield et al, issued Mar. 13, 1979 and in U.S. Pat. No. 3,308,067, Diehl, issued Mar. 7, 1967. See also U.S. Pat. No. 3,723,322.

Where phosphorus-based builders can be used, the various alkali metal phosphates such as the well-known sodium tripolyphosphates, sodium pyrophosphate and sodium orthophosphate can be used. Phosphonate builders such as ethane-1-hydroxy-1,1-diphosphonate and other known phosphonates (see, for example, U.S. Pat. Nos. 3,159,581; 3,213,030; 3,422,021; 3,400,148 and 3,422,137) can also be used though such materials are more commonly used in a low-level mode as chelants or stabilizers.

Fatty acids, e.g., C₁₂-Cl₈ monocarboxylic acids, can also be incorporated into the compositions alone, or in combination with the aforementioned builders, especially citrate and/or the succinate builders, to provide additional builder activity but are generally not desired. Such use of fatty acids will generally result in a diminution of sudsing in laundry compositions, which can need to be taken into account by the formulator. Fatty acids or their salts are undesirable in Automatic Dishwashing (ADD) embodiments in situations wherein soap scums can form and be deposited on dishware.

(c) Suds Suppressor

The signal-providing compositions of the present invention can optionally contain an alkyl phosphate ester suds suppressor, a silicone suds suppressor, or combinations thereof. Levels in general are from 0% to about 10%, preferably, from about 0.001% to about 5%. However, generally (for cost and/or deposition considerations) preferred compositions herein do not comprise suds suppressors or comprise suds suppressors only at low levels, e.g., less than about 0.1% of active suds suppressing agent.

Silicone suds suppressor technology and other defoaming agents useful herein are extensively documented in “Defoaming, Theory and Industrial Applications”, Ed., P.R. Garrett, Marcel Dekker, N.Y., 1973, ISBN 0-8247-8770-6, incorporated herein by reference. See especially the chapters entitled “Foam control in Detergent Products” (Ferch et al) and “Surfactant Antifoams” (Blease et al). See also U.S. Pat. Nos. 3,933,672 and 4,136,045. Highly preferred silicone suds suppressors are the compounded types known for use in laundry detergents such as heavy-duty granules, although types hitherto used only in heavy-duty liquid detergents can also be incorporated in the instant compositions. For example, polydimethylsiloxanes having trimethylsilyl or alternate endblocking units can be used as the silicone. These can be compounded with silica and/or with surface-active non-silicon components, as illustrated by a suds suppressor comprising 12% silicone/silica, 18% stearyl alcohol and 70% starch in granular form. A suitable commercial source of the silicone active compounds can be Dow Corning Corp. if it can be desired to use a phosphate ester, suitable compounds are disclosed in U.S. Pat. No. 3,314,891, issued Apr. 18, 1967, to Schmolka et al, incorporated herein by reference. Preferred alkyl phosphate esters contain from 16-20 carbon atoms. Highly preferred alkyl phosphate esters are monostearyl acid phosphate or monooleyl acid phosphate, or salts thereof, particularly alkali metal salts, or mixtures thereof.

It has been found preferable to avoid the use of simple calcium-precipitating soaps as antifoams in the present compositions as they tend to deposit on the dishware. Indeed, phosphate esters are not entirely free of such problems and the formulator will generally choose to minimize the content of potentially depositing antifoams in the instant compositions.

One embodiment of the present invention relates to a signal-providing composition, wherein the suds suppressor can be selected from the group consisting of low-foaming nonionic surfactants, low-foaming nonionic surfactants with a cloud point below about 30° C., alkoxylates or mixed alkoxylates of linear fatty alcohols, alkoxylates or mixed alkoxylates of alkylphenols, block co-polymers of ethylene and propylene glycol, C_{9/11}EO₈-cyclohexyl acetal alkyl capped nonionic, C₁₁EO₇-n-butyl acetal, C^{9/11}EO₈-2-ethylhexyl acetal, C₁₁EO₈-pyranyl, alcohol alkoxylate, and mixtures thereof.

(d) Perfume

(i) Non-Blooming Perfumes—Perfumes and perfumery ingredients useful in the present compositions and processes comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes typically comprise from about 0.01% to about 2%, by weight, of the detergent compositions herein, and individual perfumery ingredients can comprise from about 0.0001% to about 90% of a finished perfume composition.

Non-limiting examples of perfume ingredients useful herein include: 7-acety-1,2,3,4,5,6,7,8-octahydro-1,1,6,7-tetramethyl naphthalene; ionone methyl; ionone gamma methyl; methyl cedrylone; methyl dihydrojasmonate; methyl 1,6,10-trimethyl-2,5,9-cyclododecatrien-1-yl ketone; 7-acetyl-1,1,3,4,4,6-hexamethyl tetralin; 4-acetyl-6-tert-butyl-1,1-dimethyl indane; parahydroxy-phenyl-butanone; benzophenone; methyl beta-naphthyl ketone; 6-acetyl-1,1,2,3,3,5-hexamethyl indane; 5-acetyl-3-isopropyl-1,1,2,6-tetramethyl indane; 1-dodecanal, 4-(4-hydroxy-4-methylpentyl)-3-cyclohexene-1-carboxaldehyde; 7-hydroxy-3,7-dimethyl ocatanal; 10-undecen-1-al; iso-hexenyl cyclohexyl carboxaldehyde; formyl tricyclodecane; condensation products of hydroxycitronellal and methyl anthranilate, condensation products of hydroxycitronellal and indol, condensation products of phenyl acetaldehyde and indol; 2-methyl-3-(para-tert-butylphenyl)-propionaldehyde; ethyl vanillin; heliotropin; hexyl cinnamic aldehyde; amyl cinnamic aldehyde; 2-methyl-2-(para-iso-propylphenyl)-propionaldehyde; coumarin; decalactone gamma; cyclopentadecanolide; 16-hydroxy-9-hexadecenoic acid lactone; 1,3,4,6,7,8-hexahydro-4,6,6,7,8,8-hexamethylcyclopenta-gamma-2-benzopyrane; beta-naphthol methyl ether; ambroxane; dodecahydro-3a,6,6,9a-tetramethylnaphtho[2,1b]furan; cedrol, 5-(2,2,3-trimethylcyclopent-3-enyl)-3-methylpentan-2-ol; 2-ethyl-4-(2,2,3-trimethyl-3-cyclopenten-1-yl)-2-buten-1-ol; caryophyllene alcohol; tricyclodecenyl propionate; tricyclodecenyl acetate; benzyl salicylate; cedryl acetate; and para-(tert-butyl) cyclohexyl acetate.

Particularly preferred perfume materials are those that provide the largest odor improvements in finished product compositions containing cellulases. These perfumes include but are not limited to: hexyl cinnamic aldehyde; 2-methyl-3-(para-tert-butylphenyl)-propionaldehyde; 7-acetyl-1,2,3,4,5,6,7,8-octahydro-1,1,6,7-tetramethyl naphthalene; benzyl salicylate; 7-acetyl-1,1,3,4,4,6-hexamethyl tetralin; para-tert-butyl cyclohexyl acetate; methyl dihydro jasmonate; beta-napthol methyl ether; methyl beta-naphthyl ketone; 2-methyl-2-(para-iso-propylphenyl)-propionaldehyde; 1,3,4,6,7,8-hexahydro4,6,6,7,8,8-hexamethyl-cyclopenta-gamma-2-benzopyrane; dodecahydro-3a,6,6,9a-tetramethylnaphtho[2,1b]furan; anisaldehyde; coumarin; cedrol; vanillin; cyclopentadecanolide; tricyclodecenyl acetate; and tricyclodecenyl propionate.

Other perfume materials include essential oils, resinoids, and resins from a variety of sources including, but not limited to: Peru balsam, Olibanum resinoid, styrax, labdanum resin, nutmeg, cassia oil, benzoin resin, coriander and lavandin. Still other perfume chemicals include phenyl ethyl alcohol, terpineol, linalool, linalyl acetate, geraniol, nerol, 2-(1,1-dimethylethyl)-cyclohexanol acetate, benzyl acetate, and eugenol. Carriers such as diethylphthalate can be used in the finished perfume compositions.

(ii) Blooming Perfumes—Blooming perfume compositions, as disclosed herein, can be formulated into automatic dishwashing detergent compositions and provide significantly better noticeability to the consumer than non-blooming perfume compositions not containing a substantial amount of blooming perfume ingredients. Additionally, residual perfume can be not desirable on many surfaces, including dishes, glasses and cutlery, especially those made of plastic, rubber and silicone.

A blooming perfume ingredient can be characterized by its boiling point (B.P.) and its octanol/water partition coefficient (P). The octanol/water partition coefficient of a perfume ingredient can be the ratio between its equilibrium concentrations in octanol and in water. The preferred perfume ingredients of this invention have a B.P., determined at the normal, standard pressure of about 760 mm Hg, of about 260° C. or lower, preferably less than about 255° C.; and more preferably less than about 250° C., and an octanol/water partition coefficent P of about 1,000 or higher. Since the partition coefficients of the preferred perfume ingredients of this invention have high values, they are more conveniently given in the form of their logarithm to the base 10, logP. Thus the preferred perfume ingredients of this invention have logP at □□□C of about 3 or higher.

One embodiment of the present invention relates to a signal-providing composition, wherein the perfume can be from about 0.01% to about 5%, by weight, a blooming perfume composition, wherein the blooming perfume composition can comprise from about 50% to about 99% of blooming perfume ingredients having a boiling point of less than about 260° C. and a ClogP of at least about 3, and wherein the blooming perfume composition comprising at least about 5 different blooming perfume ingredients, and from about 0.5% to about 10% of base masking perfume ingredients having a boiling point of more than about 260° C. and a C log P of at least about 3.

The following U.S. Patents disclose perfumes: U.S. Pat. No. 6,143,707; U.S. Pat. No. 6,228,821; U.S. Pat. No. 5,929,022; and U.S. Pat. No. 5,670,466.

(e) Bleach-Scavenging Agent

Additionally, from 0% to about 10%, preferably from about 0.01% to about 6% by weight, of bleach-scavengers can be added to compositions of the present invention to prevent chlorine and/or oxygen bleach species present in the wash and/or rinse liquor as well as in many water supplies from attacking and inactivating the enzymes, especially under alkaline conditions. While chlorine levels in water can be small, typically in the range from about 0.5 ppm to about 1.75 ppm, the available chlorine in the total volume of water that comes in contact with the enzyme during dishwashing can be usually large; accordingly, enzyme stability in-use can be problematic.

Suitable bleach-scavenger anions are salts containing ammonium cations. These can be selected from the group consisting of reducing materials like sulfite, bisulfite, thiosulfite, thiosulfate, iodide, etc., antioxidants like carbonate, ascorbate, etc., organic amines such as ethylenediaminetetracetic acid (EDTA) or alkali metal salt thereof and monoethanolamine (MEA), and mixtures thereof. Other conventional scavenging anions like sulfate, bisulfate, carbonate, bicarbonate, percarbonate, nitrate, chloride, borate, sodium perborate tetrahydrate, sodium perborate monohydrate, percarbonate, phosphate, condensed phosphate, acetate, benzoate, citrate, formate, lactate, malate, tartrate, salicylate, etc. and mixtures thereof can also be used.

One embodiment of the present invention relates to a bleach-scavenging agent selected from the group consisting of perborate, percarbonate, ascorbic acid or derivatives thereof, carbamate, ammonium, sulfite, bisulfite, aluminum tristearate, sodium silicate, benzotriazole, amines, amino acids, and mixtures thereof. Another embodiment of the present invention relates to a signal-providing composition that does not contain chlorine bleach, oxygen bleach, and mixtures thereof.

(f) Metal-Protecting Agent

The present signal-providing compositions can contain one or more material care agents which are effective as corrosion inhibitors and/or anti-tarnish aids. Such materials are preferred components of machine dishwashing compositions especially in certain European countries where the use of electroplated nickel silver and sterling silver can be still comparatively common in domestic flatware, or when aluminium protection can be a concern and the composition can be low in silicate. Generally, such material care agents include metasilicate, silicate, bismuth salts, manganese salts, paraffin, triazoles, pyrazoles, thiols, mercaptans, aluminium fatty acid salts, and mixtures thereof.

When present, such protecting materials are preferably incorporated at low levels, e.g., from about 0.01% to about 5% of the signal-providing composition. Suitable corrosion inhibitors include paraffin oil, typically a predominantly branched aliphatic hydrocarbon having a number of carbon atoms in the range of from about 20 to about 50; preferred paraffin oil can be selected from predominantly branched C₂₅₋₄₅ species with a ratio of cyclic to noncyclic hydrocarbons of about 32:68. A paraffin oil meeting those characteristics can be sold by Wintershall, Salzbergen, Germany, under the trade name WINOG 70. Additionally, the addition of low levels of bismuth nitrate (i.e., Bi(NO₃)₃) can be also preferred.

Other corrosion inhibitor compounds include benzotriazole and comparable compounds; mercaptans or thiols including thionaphtol and thioanthranol; and finely divided Aluminium fatty acid salts, such as aluminium tristearate. The formulator will recognize that such materials will generally be used judiciously and in limited quantities so as to avoid any tendency to produce spots or films on glassware or to compromise the bleaching action of the compositions. For this reason, mercaptan anti-tarnishes which are quite strongly bleach-reactive and common fatty carboxylic acids which precipitate with calcium in particular are preferably avoided.

One embodiment of the present invention relates to a metal-protecting agent selected from the group consisting of perborate, percarbonate, ascorbic acid or derivatives thereof, carbamate, ammonium, sulfite, bisulfite, aluminum tristearate, sodium silicate, benzotriazole, amines, amino acids, and mixtures thereof.

Adjunct Ingredients as Signal-Providing Agents

Detersive ingredients or adjuncts optionally included in the instant signal-providing compositions can include one or more materials for assisting or enhancing cleaning, sanitizing and stain removal performance of tableware treated by electrolyzed water in an automatic dishwashing appliance containing an electrochemical cell and/or electrolytic device. They themselves can be the signal-proving agent of the present invention and are further selected based on the form of the composition, i.e., whether the composition can be to be sold as a liquid, paste (semi-solid), or solid form (including tablets and the preferred granular forms for the present compositions).

Adjuncts which can also be included in signal-providing detergent compositions of the present invention, at their conventional art-established levels for use (generally, adjunct materials comprise, in total, from about 1% to about 90%, preferably from about 5% to about 75%, more preferably from about 10% to about 50%, by weight of the compositions), and can include other active ingredients such as nanoparticles, functionalized surface molecules, polymers, surfactants, co-surfactants, metal ions, proteins, dyes, acids, bases, organic solvents, enzymes, enzyme stabilizing systems, chelants, optical brighteners, soil release agents, wetting agents, dispersants, blooming perfumes, colorants, filler salts, hydrotropes, anti-oxidants, germicides, fungicides, color speckles, silvercare, anti-tanishing agents, alkalinity sources, solubilizing agents, carriers, electrode maintenance and/or descaling agents, processing aids, pigments, and pH control agents, bleaching agent, bleach activators, bleach catalysts and mixtures thereof. These adjuncts are described in detail in U.S. Pat. No. 6,143,707, Trinh et al., incorporated herein by reference.

The precise nature of these additional detergent ingredients, and levels of incorporation thereof, will depend on the physical form of the composition and the nature of the operation for which the composition can be to be used. The selection of the adjunct will depend upon the type and use of the composition. Non-limiting illustrative examples of compositions as well as suitable adjunct(s) for the illustrative compositions are described hereinafter. Particularly preferred adjuncts are surfactants, enzymes, chelants, dispersant polymers, thickeners, and pH adjusting agents as described in detail hereinafter.

(a) Surfactant

One embodiment of the present invention relates to a signal-providing composition comprising a surfactant can be selected from the group consisting of anionic surfactants, cationic surfactants, nonionic surfactants, amphoteric surfactants, ampholytic surfactants, zwitterionic surfactants, and mixtures thereof.

It should be noted that low foaming nonionic surfactants are useful in automatic dishwashing to assist cleaning, help defoam food soil foams, especially from proteins, and to help control spotting/filming and are desirably included in the present detergent compositions at levels of from about 0.1% to about 20%, preferably from about 0.5% to about 5%, by weight of the composition. In general, bleach-stable surfactants are preferred signal-providing compositions of the present invention preferably comprise low foaming nonionic surfactants (LFNIs).

LFNIs are most typically used in ADDs on account of the improved water-sheeting action (especially from glass) which they confer to the signal-providing composition. They also encompass non-silicone, nonphosphate polymeric materials further illustrated hereinafter which are known to defoam food soils encountered in automatic dishwashing.

Preferred LFNIs include nonionic alkoxylated surfactants, especially ethoxylates derived from primary alcohols, and blends thereof with more sophisticated surfactants, such as the polyoxypropylene/polyoxyethylene/polyoxypropylene (PO/EO/PO) reverse block polymers. The PO/EO/PO polymer-type surfactants are well-known to have foam suppressing or defoaming action, especially in relation to common food soil ingredients such as egg.

In a preferred embodiment, the LFNI can be an ethoxylated surfactant derived from the reaction of a monohydroxy alcohol or alkylphenol containing from about 8 to about 20 carbon atoms, with from about 6 to about 15 moles of ethylene oxide per mole of alcohol or alkyl phenol on an average basis.

A particularly preferred LFNI can be derived from a straight chain fatty alcohol containing from about 16 to about 20 carbon atoms (C₁₆-C₂₀ alcohol), preferably a C₁₈ alcohol, condensed with an average of from about 6 to about 15 moles, preferably from about 7 to about 12 moles, and most preferably from about 7 to about 9 moles of ethylene oxide per mole of alcohol. Preferably the ethoxylated nonionic surfactant so derived has a narrow ethoxylate distribution relative to the average.

The LFNI can optionally contain propylene oxide in an amount up to about 15% by weight. Other preferred LFNI surfactants can be prepared by the processes described in U.S. Pat. No. 4,223,163, issued Sep. 16, 1980, Builloty, incorporated herein by reference.

Highly preferred ADDs herein wherein the LFNI can be present make use of ethoxylated monohydroxy alcohol or alkyl phenol and additionally comprise a polyoxyethylene, polyoxypropylene block polymeric compound; the ethoxylated monohydroxy alcohol or alkyl phenol fraction of the LFNI comprising from about 20% to about 100%, preferably from about 30% to about 70%, of the total LFNI.

Suitable block polyoxyethylene-polyoxypropylene polymeric compounds that meet the requirements described hereinbefore include those based on ethylene glycol, propylene glycol, glycerol, trimethylolpropane and ethylenediamine as initiator reactive hydrogen compound. Polymeric compounds made from a sequential ethoxylation and propoxylation of initiator compounds with a single reactive hydrogen atom, such as C₁₂₋₁₈ aliphatic alcohols, do not generally provide satisfactory suds control in the instant ADDs. Certain of the block polymer surfactant compounds designated PLURONIC® and TETRONIC® by the BASF-Wyandotte Corp., Wyandotte, Mich., are suitable in signal-providing compositions of the invention.

A particularly preferred LFNI contains from about 40% to about 70% of a polyoxypropylene/polyoxyethylene/polyoxypropylene block polymer blend comprising about 75%, by weight of the blend, of a reverse block co-polymer of polyoxyethylene and polyoxypropylene containing 17 moles of ethylene oxide and 44 moles of propylene oxide; and about 25%, by weight of the blend, of a block co-polymer of polyoxyethylene and polyoxypropylene initiated with trimethylolpropane and containing 99 moles of propylene oxide and 24 moles of ethylene oxide per mole of trimethylolpropane.

Suitable for use as LFNI in the signal-providing compositions are those LFNI having relatively low cloud points and high hydrophilic-lipophilic balance (HLB). Cloud points of 1% solutions in water are typically below about 32° C. and preferably lower, e.g., 0° C., for optimum control of sudsing throughout a full range of water temperatures.

LFNIs which can also be used include a C₁₈ alcohol polyethoxylate, having a degree of ethoxylation of about 8, commercially available as SLF18 from Olin Corp., and any biodegradable LFNI having the melting point properties discussed hereinabove.

(b) Co-Surfactant

The composition of the present invention can further contain optional co-surfactants. These optional surfactants will be preferably bleach stable. Preferred optional co-surfactants are low cloud point nonionic surfactants, high cloud point nonionic surfactants, anionic surfactants and mixtures thereof.

Nonionic co-surfactants useful in the present invention Automatic Dishwashing compositions are when present desirably included in the present detergent compositions at levels of from about 0.1% to about 15% of the composition. In general, bleach-stable co-surfactants are preferred. Nonionic surfactants generally are well known, being described in more detail in Kirk Othmer's Encyclopedia of Chemical Technology, 3rd Ed., Vol. 22, pp. 360-379, “Surfactants and Detersive Systems”.

“Cloud point”, as used herein, can be a well known property of nonionic surfactants which can be the result of the surfactant becoming less soluble with increasing temperature, the temperature at which the appearance of a second phase can be observable can be referred to as the “cloud point” (See Kirk Othmer, pp. 360-362, hereinbefore).

As used herein, a “low cloud point nonionic co-surfactant” can be defined as a nonionic surfactant system ingredient having a cloud point of less than about 30□C, preferably less than about 20□C, and most preferably less than about 10□C. Typical low cloud point nonionic co-surfactants include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic co-surfactants include, for example, ethoxylatedpropoxylated alcohol (e.g., Olin Corporation's Poly-Tergent® SLF18) and epoxy-capped poly(oxyalkylated) alcohols (e.g., Olin Corporation's Poly-Tergent® SLF18B series of nonionics, as described, for example, in WO 94/22800, published Oct. 13, 1994 by Olin Corporation).

Nonionic co-surfactants can optionally contain propylene oxide in an amount up to about 15% by weight. Other preferred nonionic co-surfactants can be prepared by the processes described in U.S. Pat. No. 4,223,163, issued Sep. 16, 1980, Builloty, incorporated herein by reference.

Low cloud point nonionic co-surfactants additionally comprise a polyoxyethylene, polyoxypropylene block polymeric compound. Block polyoxyethylene-polyoxypropylene polymeric compounds include those based on ethylene glycol, propylene glycol, glycerol, trimethylolpropane and ethylenediamine as initiator reactive hydrogen compound. Certain of the block polymer surfactant compounds designated PLURONIC®, REVERSED PLURONICO®, and TETRONIC® by the BASF-Wyandotte Corp., Wyandotte, Mich., are suitable in signal-providing compositions of the invention. Preferred examples include REVERSED PLURONIC® 25R2 and TETRONIC® 702, Such co-surfactants are typically useful herein as low cloud point nonionic surfactants.

As used herein, a “high cloud point nonionic co-surfactant” can be defined as a nonionic surfactant system ingredient having a cloud point of greater than 40□C, preferably greater than about 50□C, and more preferably greater than about 60□C. Preferably the nonionic co-surfactant system can comprise an ethoxylated surfactant derived from the reaction of a monohydroxy alcohol or alkylphenol containing from about 8 to about 20 carbon atoms, with from about 6 to about 15 moles of ethylene oxide per mole of alcohol or alkyl phenol on an average basis. Such high cloud point nonionic co-surfactants include, for example, Tergitol 15S9 (supplied by Union Carbide), Rhodasurf TMD 8.5 (supplied by Rhone Poulenc), and Neodol 91-8 (supplied by Shell).

It can be also preferred for purposes of the present invention that the high cloud point nonionic co-surfactant further have a hydrophile-lipophile balance (“HLB”; see Kirk Othmer hereinbefore) value within the range of from about 9 to about 15, preferably 11 to 15. Such materials include, for example, Tergitol 15S9 (supplied by Union Carbide), Rhodasurf TMD 8.5 (supplied by Rhone Poulenc), and Neodol 91-8 (supplied by Shell).

Another preferred high cloud point nonionic co-surfactant can be derived from a straight or preferably branched chain or secondary fatty alcohol containing from about 6 to about 20 carbon atoms (C₆-C₂₀ alcohol), including secondary alcohols and branched chain primary alcohols. Preferably, high cloud point nonionic co-surfactants are branched or secondary alcohol ethoxylates, more preferably mixed C9/11 or C11/15 branched alcohol ethoxylates, condensed with an average of from about 6 to about 15 moles, preferably from about 6 to about 12 moles, and most preferably from about 6 to about 9 moles of ethylene oxide per mole of alcohol. Preferably the ethoxylated nonionic co-surfactant so derived has a narrow ethoxylate distribution relative to the average.

When the optional co-surfactants are a mixture of low cloud point nonionics and high cloud point nonionics it can be preferred that the mixture can be combined in a weight ratio preferably within the range of from about 10:1 to about 1:10.

The anionic co-surfactant can be selected from alkylethoxycarboxylates, alkylethoxysulfates, with the degree of ethoxylation greater than 3 (preferably 4 to 10; more preferably 6 to 8), and chain length in the range of C8 to C16, preferably 11-15. Additionally, branched alkylcarboxylates have been found to be useful in signal-providing compositions when the branch occurs in the middle and the average total chain length can be 10 to 18, preferably 12-16 with the side branch 2-4 carbons in length. An example can be 2-butyloctanoic acid. The anionic co-surfactant can be typically of a type having good solubility in the presence of calcium. Such anionic co-surfactants are further illustrated by alkyl(polyethoxy)sulfates (AES), alkyl (polyethoxy)carboxylates (AEC), and short chained C₆-C₁₀ alkyl sulfates and sulfonates. Straight chain fatty acids have been shown to be ineffective due to their sensitivity to calcium.

(c) Enzyme

“Detergent enzyme”, as used herein, means any enzyme having a cleaning, stain removing or otherwise beneficial effect in a signal-providing composition. Preferred enzymes are hydrolases such as proteases, amylases and lipases. Highly preferred for automatic dishwashing are amylases and/or proteases, including both current commercially available types and improved types which, though more bleach compatible, have a remaining degree of bleach deactivation susceptibility.

Enzyme-containing compositions, especially liquid compositions, herein can comprise from about 0.001% to about 10%, preferably from about 0.005% to about 8%, most preferably from about 0.01% to about 6%, by weight of an enzyme stabilizing system. The enzyme stabilizing system can be any stabilizing system which can be compatible with the detersive enzyme. Such stabilizing systems can comprise calcium ion, boric acid, propylene glycol, short chain carboxylic acid, boronic acid, and mixtures thereof.

One embodiment of the present invention relates to a liquid and/or gel automatic dishwashing composition for treating tableware in an automatic dishwashing appliance comprising an electrochemical cell for improved tableware cleaning, sanitizing, and/or stain removal, the composition comprising: (a) at least about 0.1%, by weight of the composition, of a halogenated salt having the formula (M)ₓ(X)_{y}, wherein X can be Cl, Br, or I and wherein M can be a metal ion or cationic entity, and wherein x and y are chosen such that the salt can be charge balanced; (b) a component selected from the group consisting of a builder, suds suppressor, perfume, a bleach-scavenging agent, a metal-protecting agent, and mixtures thereof; and (c) an effective amount of an enzyme; and (d) an effective amount of a thickening agent; wherein the liquid and/or gel composition can be optionally free of bleach. Another embodiment of the present invention relates to a signal-providing composition, wherein the composition does not contain chlorine bleach, oxygen bleach, or mixtures thereof.

The signal-providing compositions herein optionally comprise one or more enzymes. If only one enzyme can be used, it can be preferably an amyolytic enzyme. Highly preferred for automatic dishwashing can be a mixture of proteolytic enzymes and amyloytic enzymes. More generally, the enzymes to be incorporated include proteases, amylases, lipases, cellulases, and peroxidases, as well as mixtures thereof. Other types of enzymes can also be included. They can be of any suitable origin, such as vegetable, animal, bacterial, fungal and yeast origin. However, their choice can be governed by several factors such as pH-activity and/or stability optima, thermostability, stability versus active detergents, builders, etc. In this respect bacterial or fungal enzymes are preferred, such as bacterial amylases and proteases, and fungal cellulases.

Enzymes are normally incorporated in the instant detergent compositions at levels sufficient to provide a “cleaning-effective amount”. The term “cleaning-effective amount” refers to any amount capable of producing a cleaning, stain removal or soil removal effect on substrates such as fabrics, tableware and the like. Since enzymes are catalytic materials, such amounts can be very small. In practical terms for current commercial preparations, typical amounts are up to about 5 mg by weight, more typically about 0.01 mg to about 3 mg, of active enzyme per gram of the composition. Stated otherwise, the compositions herein will typically comprise from about 0.001% to about 6%, preferably 0.01%-1% by weight of a commercial enzyme preparation. Protease enzymes are usually present in such commercial preparations at levels sufficient to provide from 0.005 to 0.1 Anson units (AU) of activity per gram of composition. For automatic dishwashing purposes, it can be desirable to increase the active enzyme content of the commercial preparations, in order to minimize the total amount of non-catalytically active materials delivered and thereby improve spotting/filming results.

Suitable examples of proteases are the subtilisins which are obtained from particular strains of B. subtilis and B. licheniformis. Another suitable protease can be obtained from a strain of Bacillus, having maximum activity throughout the pH range of 8-12, developed and sold by Novo Industries A/S as ESPERASE®. The preparation of this enzyme and analogous enzymes can be described in British Patent Specification No. 1,243,784 of Novo. Proteolytic enzymes suitable for removing protein-based stains that are commercially available include those sold under the tradenames ALCALASE® and SAVINASE® by Novo Industries A/S (Denmark). Other proteases include Protease A (see European Patent Application 130,756, published Jan. 9, 1985) and Protease B (see European Patent Application Serial No. 87303761.8, filed Apr. 28, 1987, and European Patent Application 130,756, Bott et al, published Jan. 9, 1985).

An especially preferred protease, referred to as “Protease D”, as described in U.S. Pat. No. 5,679,630, Baeck, et al, and U.S. Pat. No. 5,677,272, Ghosh, et al, both incorporated herein by reference. Amylases suitable herein include, for example, α-amylases described in British Patent Specification No. 1,296,839 (Novo).

Engineering of enzymes (e.g., stability-enhanced amylase) for improved stability, e.g., oxidative stability can be known. See, for example, J.Biological Chem., Vol. 260, No. 11, June 1985, pp 6518-6521. “Reference amylase” refers to a conventional amylase inside the scope of the amylase component of this invention. Further, stability-enhanced amylases, also within the invention, are typically compared to these “reference amylases”.

The present invention, in certain preferred embodiments, can make use of amylases having improved stability in detergents, especially improved oxidative stability. A convenient absolute stability reference-point against which amylases used in these preferred embodiments of the instant invention represent a measurable improvement can be the stability of TERMAMYL® in commercial use in 1993 and available from Novo Nordisk A/S. This TERMAMYL® amylase can be a “reference amylase”, and can be itself well-suited for use in the signal-providing compositions of the invention.

Even more preferred amylases herein share the characteristic of being “stabilityenhanced” amylases, characterized, at a minimum, by a measurable improvement in one or more of: oxidative stability, e.g., to hydrogen peroxide/tetraacetylethylenediamine in buffered solution at pH 9-10; thermal stability, e.g., at common wash temperatures such as about 60° C.; or alkaline stability, e.g., at a pH from about 8 to about 11, all measured versus the above-identified reference-amylase. Preferred amylases herein can demonstrate further improvement versus more challenging reference amylases, the latter reference amylases being illustrated by any of the precursor amylases of which preferred amylases within the invention are variants. Such precursor amylases can themselves be natural or be the product of genetic engineering. Stability can be measured using any of the art-disclosed technical tests. See references disclosed in WO 94/02597.

In general, stability-enhanced amylases respecting the preferred embodiments of the invention can be obtained from Novo Nordisk A/S, or from Genencor International. Preferred amylases herein have the commonality of being derived using site-directed mutagenesis from one or more of the Baccillus amylases, especialy the Bacillus alpha-amylases, regardless of whether one, two or multiple amylase strains are the immediate precursors.

Such amylases are non-limitingly illustrated by the following:

(i) An amylase according to the hereinbefore incorporated WO/94/02597, Novo Nordisk A/S, published Feb. 3, 1994, as further illustrated by a mutant in which substitution can be made, using alanine or threonine (preferably threonine), of the methionine residue located in position 197 of the B. licheniformis alpha-amylase, known as TERMAMYL®, or the homologous position variation of a similar parent amylase, such as B. amyloliquefaciens, B.subtilis, or B. stearothermophilus;

(ii) Stability-enhanced amylases as described by Genencor International in a paper entitled “Oxidatively Resistant alpha-Amylases” presented at the 207th American Chemical Society National Meeting, March 13-17, 1994, by C. Mitchinson. Therein it was noted that bleaches in automatic dishwashing detergents inactivate alpha-amylases but that improved oxidative stability amylases have been made by Genencor from B. licheniformis NCIB8061. Methionine (Met) was identified as the most likely residue to be modified. Met was substituted, one at a time, in positions 8,15,197,256,304,366 and 438 leading to specific mutants, particularly important being M197L and M197T with the M197T variant being the most stable expressed variant. Stability was measured in CASCADE® and SUNLIGHT®;

(iii) Particularly preferred herein are amylase variants having additional modification in the immediate parent available from Novo Nordisk A/S. These amylases do not yet have a tradename but are those referred to by the supplier as QL37+M197T.

Any other oxidative stability-enhanced amylase can be used, for example as derived by site-directed mutagenesis from known chimeric, hybrid or simple mutant parent forms of available amylases.

A wide range of enzyme materials and means for their incorporation into synthetic detergent compositions are also disclosed in U.S. Pat. No. 3,553,139, issued Jan. 5, 1971 to McCarty et al. Enzymes are further disclosed in U.S. Pat. No. 4,101,457, Place et al, issued Jul. 18, 1978, and in U.S. Pat. No. 4,507,219, Hughes, issued Mar. 26, 1985, and in the above incorporated U.S. Pat. No. 6,143,707, Trinh et al, issued Nov. 7, 2000. Enzymes for use in detergents can be stabilized by various techniques. Enzyme stabilization techniques are disclosed and exemplified in U.S. Pat. No. 3,600,319, issued Aug. 17, 1971 to Gedge, et al, and European Patent Application Publication No. 0 199 405, Application No. 86200586.5, published Oct. 29, 1986, Venegas. Enzyme stabilization systems are also described, for example, in U.S. Pat. No. 3,519,570.

(d) Chelating Agents

The compositions herein can also optionally contain one or more transition-metal selective sequestrants, “chelants” or “chelating agents”, e.g., iron and/or copper and/or manganese chelating agents. Chelating agents suitable for use herein can be selected from the group consisting of aminocarboxylates, phosphonates (especially the aminophosphonates), polyfunctionally-substituted aromatic chelating agents, and mixtures thereof. Without intending to be bound by theory, it can be believed that the benefit of these materials can be due in part to their exceptional ability to control iron, copper and manganese in washing solutions which are known to decompose hydrogen peroxide and/or bleach activators; other benefits include inorganic film prevention or scale inhibition. Commercial chelating agents for use herein include the DEQUEST® series, and chelants from Monsanto, DuPont, and Nalco, Inc.

Aminocarboxylates useful as optional chelating agents are further illustrated by ethylenediaminetetracetates, N-hydroxyethylethylenediaminetriacetates, nitrilo-triacetates, ethylenediamine tetraproprionates, triethylenetetraaminehexacetates, diethylenetriamine-pentaacetates, and ethanoldiglycines, alkali metal, ammonium, and substituted ammonium salts thereof. In general, chelant mixtures can be used for a combination of functions, such as multiple transition-metal control, long-term product stabilization, and/or control of precipitated transition metal oxides and/or hydroxides.

Polyfunctionally-substituted aromatic chelating agents are also useful in the compositions herein. See U.S. Pat. No. 3,812,044, issued can 21, 1974, to Connor et al. Preferred compounds of this type in acid form are dihydroxydisulfobenzenes such as 1,2-dihydroxy-3,5-disulfobenzene.

A highly preferred biodegradable chelator for use herein can be ethylenediamine disuccinate (“EDDS”), especially (but not limited to) the [S,S] isomer as described in U.S. Pat. No. 4,704,233, Nov. 3, 1987, to Hartman and Perkins. The trisodium salt can be preferred though other forms, such as magnesium salts, can also be useful.

Aminophosphonates are also suitable for use as chelating agents in the compositions of the invention when at least low levels of total phosphorus are acceptable in detergent compositions, and include the ethylenediaminetetrakis (methylenephosphonates) and the diethylenetriaminepentakis (methylene phosphonates). Preferably, these aminophosphonates do not contain alkyl or alkenyl groups with more than about 6 carbon atoms.

If utilized, chelating agents or transition-metal-selective sequestrants will preferably comprise from about 0.001% to about 10%, more preferably from about 0.05% to about 1% by weight of the compositions herein.

One embodiment of the present invention relates to a signal-providing composition comprising a chelant selected from the group consisting of EDTA, tetraacetyl ethylene diamine (TAED), EDDS, aminophosphonates, aminocarboxylates, carboxylatephosphonates, aluminosilicates, magnesioaluminosiliates, polyfunctionally-substituted aromatic chelating agents, and mixtures thereof.

(e) Dispersant Polymer

Preferred signal-providing compositions herein can additionally contain a dispersant polymer. When present, a dispersant polymer in the instant signal-providing compositions can be typically at levels in the range from 0 to about 25%, preferably from about 0.5% to about 20%, more preferably from about 1% to about 8%, by weight of the signal-providing composition. Dispersant polymers are useful for improved filming performance of the present signal-providing compositions, especially in higher pH embodiments, such as those in which wash pH exceeds about 9.5. Particularly preferred are polymers which inhibit the deposition of calcium carbonate or magnesium silicate on dishware.

Dispersant polymers suitable for use herein are further illustrated by the film-forming polymers described in U.S. Pat. No. 4,379,080 (Murphy), issued Apr. 5, 1983. Suitable polymers are preferably at least partially neutralized or alkali metal, ammonium or substituted ammonium (e.g., mono-, di- or triethanolammonium) salts of polycarboxylic acids. The alkali metal, especially sodium salts are most preferred. While the molecular weight of the polymer can vary over a wide range, it preferably can be from about 1,000 to about 500,000, more preferably can be from about 1,000 to about 250,000, and most preferably, especially if the signal-providing can be for use in North American automatic dishwashing appliances, can be from about 1,000 to about 5,000.

Other suitable dispersant polymers include those disclosed in U.S. Pat. Nos. 3,308,067, 4,530,766, 3,723,322, 3,929,107, 3,803,285, 3,629,121, 4,141,841, and 5,084,535; EP Pat. No. 66,915.

Copolymers of acrylamide and acrylate having a molecular weight of from about 3,000 to about 100,000, preferably from about 4,000 to about 20,000, and an acrylamide content of less than about 50%, preferably less than about 20%, by weight of the dispersant polymer can also be used.

Particularly preferred dispersant polymers are low molecular weight modified polyacrylate copolymers. Suitable low molecular weight polyacrylate dispersant polymer preferably has a molecular weight of less than about 15,000, preferably from about 500 to about 10,000, most preferably from about 1,000 to about 5,000. The most preferred polyacrylate copolymer for use herein has a molecular weight of about 3,500 and can be the fully neutralized form of the polymer comprising about 70% by weight acrylic acid and about 30% by weight methacrylic acid.

Other dispersant polymers useful herein include the polyethylene glycols and polypropylene glycols having a molecular weight of from about 950 to about 30,000 which can be obtained from the Dow Chemical Company of Midland, Mich.

Yet other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate can be the most preferred polymer of this group. Yet another group of acceptable dispersants are the organic dispersant polymers, such as polyaspartate.

One embodiment of the present invention relates to a signal-providing composition comprising a dispersant polymer selected from the group consisting of poly (acrylic/allyl alcohol), poly (acrylic/maleic), poly (a-hydroxyacrylic acid), poly (tetramathylene-1,2-dicarbocylic acid), poly (4-methocy-tetramethylene-1,2-tetramethylene-1,2-dicarbocylic acid), polyacrylates, acrylic acid/maleic acid copolymers, polyalkyleneglycols, polyaminoacids, carboxyalkylcelluloses, alkylated or hydroxyalkylated celluloses, ether hydroxypolycarboxylates, polyvinylpyrrolidone, polyvinylpyridine-N-oxide, poly(vinylpyrrolidone)-co-poly(vinylimidazole), polydimethylsiloxanes, polydimethylsiloxanes, trisiloxanes with pendant polyethylene, polyethylene/polypropylene sidechains, water soluble salts, and combinations thereof.

(c) Thickeners

The physical stability of the liquid or gel product can be improved, and the thickness of the product can be altered, by the addition of a cross-linking thickener to the liquid or gel detergent product as a thixotropic thickener.

Thickeners for use herein include those selected from clay, polycarboxylates, such as Polygel®, gums, carboxymethyl cellulose, polyacrylates, and mixtures thereof. The preferred clay type herein has a double-layer structure. The clay can be naturally occurring, e.g., Bentonites, or artificially made, e.g., Laponite®. Laponite® can be supplied by Southern Clay Products, Inc. See The Chemistry and Physics of Clays, Grimshaw, 4^{th} ed., 1971, pages 138-155, Wiley-Interscience.

One embodiment of the present invention relates to a signal-providing composition comprising a nanoparticle and/or functional colloidal particle selected from the group consisting of: (a) inorganic metal oxides, natural clays, synthetic clays and mixtures thereof; (b) synthetic clays selected from the group consisting of kaolinite, montmorillinite/smectite, smectite, hectorite, synthetic flurohectorite, illite, variants and isomorphous substitutions of the synthetic clay groups and mixtures thereof; and (c) synthetic clays selected from the group consisting of layered hydrous silicate, layered hydrous aluminum silicate, fluorosilicate, mica-montmorillonite, hydrotalcite, lithium magnesium silicate, lithium magnesium fluorosilicate and mixtures thereof.

(d) Functionalized Surface Molecules

The functionalized surface molecule of the present invention can be present in the composition to provide hydrophilic or hydrophobic character to the composition, to anchor and/or enhance surface adsorption of the tableware, and/or to provide water-affinity to treated tableware.

One embodiment of the present invention relates to a signal-providing composition comprising a functionalized surface molecule or component and/or compound selected from the group consisting of monomeric materials, polymers, copolymers and mixtures thereof, wherein at least one segment and/or group of the monomeric material and/or polymer can comprise functionality selected from the group consisting of providing hydrophilic or hydrophobic character to the monomeric material and/or polymer, anchoring and/or enhancing adsorption on solid surfaces, providing water-affinity to the monomeric material and/or polymer, and combinations thereof.

(e) PH Adjusting Components

The above liquid or gel detergent product can be preferably low foaming, readily soluble in the washing medium and most effective at pH values best conducive to improved cleaning performance, such as in a range of desirably from about pH 6.5 to about pH 12.5, and preferably from about pH 7.0 to about pH 12.0, more preferably from about pH 8.0 to about pH 12.0. Preferably the pH can be less than about 10.0 for better enzyme stability, most preferably less than about 9.0. The pH adjusting components are desirably selected from sodium or potassium hydroxide, sodium or potassium carbonate or sesquicarbonate, sodium or potassium silicate, boric acid, sodium or potassium bicarbonate, sodium or potassium borate, and mixtures thereof. NaOH or KOH are the preferred ingredients for increasing the pH to within the above ranges. Other preferred pH adjusting ingredients are sodium carbonate, potassium carbonate, and mixtures thereof.

(f) Organic Solvent

One embodiment of the present invention relates to a signal-providing composition comprising an organic solvent selected from the group consisting of low molecular weight aliphatic or aromatic alcohols, low molecular weight alkylene glycols, low molecular weight alkylene glycol ethers, low molecular weight esters, low molecular weight alkylene amines, low molecular weight alkanolamines, and mixtures thereof.

(g) Bleach, Bleach. Bleach Catalyst and/or Bleach Activator

One embodiment of the present invention relates to a signal-providing composition comprising a bleach, bleach catalyst and/or bleach activator can be selected from the group consisting of benzoyl peroxide, ε-phthalimidoperoxyhexanoic acid, 6-nonylamino-6-oxoperoxycaproic acid, tetraacetyl ethylene diamine, benzoylcaprolactam, nonanoyloxybenzenesulphonate (NOBS), decanoyloxybenzenesulphonate, (6-octanamidocaproyl)oxybenzenesulfonate, (6-nonanamidocaproyl)oxybenzenesulfonate, (6-decanamidocaproyl)oxybenzenesulfonate, magnesium monoperoxyphthalate, quaternary substituted bleach activators, and mixtures thereof.

(h) Electrochemically-Activated Pro-Benefit Agent

Another embodiment of the present invention relates to a signal-providing composition comprising an electrochemically-activated pro-benefit agent selected from the group consisting of pro-perfume, pro-oxidant, pro-reductant, pro-surface active agent, pro-glass care agent, and mixtures thereof, wherein when the electrochemically-activated pro-benefit agent is exposed to at least one electrochemical cell it undergoes oxidation and/or reduction and can be thereby converted into an active agent which provides a treatment benefit to tableware upon contact with the tableware, and wherein the benefit can be selected from the group consisting of cleaning, aesthetic, disinfecting, stain-removal, dish-care, and combinations thereof.

(i) Moisture Content

Since signal-providing compositions herein can contain water-sensitive ingredients or ingredients which can co-react when brought together in an aqueous environment, it can be desirable to keep the free moisture content of the automatic dishwashing detergent (ADD) at a minimum, e.g., 7% or less, preferably 4% or less of the ADD; and to provide packaging which can be substantially impermeable to water and carbon dioxide. Coating measures have been described herein to illustrate a way to protect the ingredients from each other and from air and moisture. Plastic bottles, including refillable or recyclable types, as well as conventional barrier cartons or boxes are another helpful means of assuring maximum shelf-storage stability. As noted, when ingredients are not highly compatible, it can further be desirable to coat at least one such ingredient with a low-foaming nonionic surfactant for protection. There are numerous waxy materials which can readily be used to form suitable coated particles of any such otherwise incompatible components; however, the formulator prefers those materials which do not have a marked tendency to deposit or form films on dishes including those of plastic construction.

One embodiment of the present invention relates to a signal-providing composition, wherein the composition can be present in the form selected from the group consisting of liquid, gel, tablet, powder, and mixtures thereof.

Embodiments

One embodiment of the present invention relates to a method of improved cleaning, sanitizing, and/or stain removal of tableware in an automatic dishwashing appliance comprising at least one attached, integrated, signal-sensing electrochemical cell and/or at least one attached, integrated electrolytic device comprising the signal-sensing cell for producing electrolyzed water, the method comprising the steps of: (a) placing tableware in need of treatment into the appliance; (b) providing the signal-sensing cell comprising at least one inlet opening and one outlet opening, and at least one pair of electrodes defining at least one cell gap comprising at least one cell passage formed therebetween through which an aqueous electrolytic solution can flow, wherein the signal-sensing cell and/or appliance further can comprise a signal sensor that can electrically and/or electronically activate and/or deactivate the production of electrolyzed water in the signal-sensing cell; (c) providing the aqueous electrolytic solution in the appliance in fluid communication with the signal-sensing cell and/or device; (d) providing at least one activator and/or deactivator; (e) intermittently activating the signal-sensing cell and/or device via the activator at least one specific time in the wash and/or rinse cycle; (f) electrolyzing the aqueous electrolytic solution in the signal-sensing cell to produce at least some electrolyzed water; (g) discharging the electrolyzed water into the wash and/or rinse liquor via a washing basin in the appliance during at least one specific time in the wash and/or rinse cycle(s); (h) interrupting electrolyzation of the aqueous electrolytic solution and/or not releasing the electrolyzed water at other times in the wash and/or rinse cycle(s); (i) contacting the tableware in need of treatment with the wash and/or rinse liquor comprising the electrolyzed water; (j) intermittently deactivating the signal-sensing cell via the deactivator during at least one specific time in the wash and/or rinse cycle(s); (k) optionally contacting the tableware with a wash and/or rinse liquor comprising a bleach-scavenging agent and/or metal-protecting agent; and (l) optionally repeating steps (c) through (k).

Another embodiment of the present invention relates to a method, wherein the signal-sensing cell and/or device comprises a characteristic selected from the group consisting of attached, integrated, unattached, self-powered, self-contained, partitioned, non-partitioned, recirculating, non-recirculating, energy-saving, disposable, non-disposable, and combinations thereof.

Another embodiment of the present invention relates to a method, wherein the cell gap having a gap spacing between about 0.1 mm to about 5.0 mm.

Another embodiment of the present invention relates to a method, wherein the aqueous electrolytic solution can comprise salts having the formula (M)ₓ(XO₂)_{y} and/or (M)ₓ(X)_{y}, wherein X can be Cl, Br, or I, wherein M can be a metal ion or cationic entity, and wherein x and y are chosen such that the salt can be charge balanced.

Another embodiment of the present invention relates to a method, wherein the sensor can be capable of analyzing the composition and/or properties of the liquid or gaseous environment within the signal-sensing cell, the device and/or the appliance, and wherein the sensor can electrically and/or electronically control the production and/or discharge of the electrolyzed water at the specific time during the wash and/or rinse cycle by turning on the activator and/or the deactivator.

Another embodiment of the present invention relates to a method, wherein the sensor can be one selected from the group consisting of turbidity sensor, water hardness sensor, pH sensor, conductivity sensor, a sensor capable of detecting the presence of a volatile gaseous compound, and combinations thereof.

Another embodiment of the present invention relates to a method, wherein the sensor can be a pH sensor, which detects the change in pH in the wash, and/or rinse liquor.

Another embodiment of the present invention relates to a method, wherein the volatile gaseous compound can be a perfume.

Another embodiment of the present invention relates to a method, wherein the location of the activator and/or deactivator can be selected from the group consisting of the signal-sensing cell, the device, the appliance, and combinations thereof.

Another embodiment of the present invention relates to a method, wherein prior to the step of providing at least one activator and/or deactivator, the method further can comprise the steps of providing a detergent composition, rinse aid composition, and mixtures thereof, and delivering the composition to the wash and/or rinse liquor; wherein the composition can comprise at least one signal-providing chemical.

Another embodiment of the present invention relates to a method, wherein the activator and/or deactivator are selected from the group consisting of chemical-based, mechanical-based, electronic-based, and combinations thereof.

Another embodiment of the present invention relates to a method, wherein the activator and/or the deactivator can be chemical-based having the ability to detect the presence and/or absence of a signal-providing chemical in the wash and/or rinse liquors and/or their corresponding gaseous vapors via the sensor in order to activate and/or deactivate the signal-sensing cell and/or device.

Another embodiment of the present invention relates to a method, wherein the appliance and/or device further comprising a timer to control production of the electrolyzed water, wherein the timer can be selected from the group consisting of mechanical timer, electric timer, electronic timer, and combinations thereof.

Another embodiment of the present invention relates to a method, wherein when the sensor detects the presence and/or absence of the signal-providing chemical in the wash and/or rinse liquor, the sensor initiates the activation of the timer such that from a certain period of time after activation of the timer, the signal-sensing cell and/or device can be activated and/or deactivated thereby controlling production and/or discharge of the electrolyzed water.

Another embodiment of the present invention relates to a method, wherein the activator and/or the deactivator can be mechanical-based having the ability to turn on and off the signal-sensing cell and/or device via a variety of cycle-linked appliance performance options on the appliance which offer the consumer a combination of cleaning performance and/or sanitization.

Another embodiment of the present invention relates to a method, wherein the activator and/or the deactivator can be electronic-based comprising a computer device that communicates with the appliance, signal-sensing cell and/or device, and combinations thereof; wherein the computer device can be pre-programmed to offer consumers a means to allow the signal-sensing cell and/or device to be turned on or off during specific wash and/or rinse cycles and settings of the appliance, and wherein the computer device can be selected from among the group consisting of programmable, non-programmable, and combinations thereof.

Another embodiment of the present invention relates to a method, wherein the appliance can comprise a universal remote control device allowing communication with the electronic-based activator and/or deactivator within the appliance, signal-sensing cell and/or device; wherein the universal remote device can be pre-programmed to offer consumers a means to allow the signal-sensing cell and/or device to be turned on and/or off at least one specific time during the wash and/or rinse cycle for most major brands of automatic dishwashing appliances available to the consumer.

Another embodiment of the present invention relates to a method, wherein the activator and/or the deactivator can be electronic-based comprising a radio-transmitting device allowing communication with the appliance, signal-sensing cell, and/or device; wherein the radio-transmitting device offers consumers a means to allow the signal-sensing cell and/or device to be turned on and/or off at least one specific time during the wash and/or rinse cycle for most major brands of automatic dishwashing appliances available to the consumer.

Another embodiment of the present invention relates to a method, wherein prior to the step of providing at least one activator and/or deactivator, the method further can comprise steps of providing a detergent composition comprising enzyme to the wash liquor, contacting the tableware with the enzymes for an effective period of time during at least one wash cycle; wherein during the cycle no electrolyzed water comes into contact with the enzymes.

Another embodiment of the present invention relates to a method, wherein the method further can comprise step of contacting the tableware with a wash and/or rinse liquor comprising a bleach-scavenging agent and/or metal-protecting agent.

Another embodiment of the present invention relates to a method, wherein the bleach-scavenging agent and/or metal-protecting agent can be selected from the group consisting of perborate, percarbonate, ascorbic acid or derivatives thereof, carbamate, ammonium, sulfite, bisulfite, aluminum tristearate, sodium silicate, benzotriazole, amines, or amino acids.

Another embodiment of the present invention relates to a method, wherein after contacting the tableware with a wash and/or rinse liquor comprising the bleach-scavenging agent and/or metal-protecting agent, no further electrolyzed water comes into contact with the dishes.

One embodiment of the present invention relates to a method, of improved cleaning, sanitizing, and/or stain removal of tableware in an automatic dishwashing appliance comprising a signal-sensing electrochemical cell and/or a signal-sensing an electrolytic device comprising the signal-sensing cell, the method using a signal system comprising a signal sensor, a signal-providing detergent composition in conjunction with the signal-sensing cell and/or device, the method comprising the steps of: (a) placing tableware in need of treatment in the appliance; (b) providing a signal-sensing system; wherein the signal-sensing cell can comprise at least one inlet opening and one outlet opening, and at least one pair of electrodes defining at least one cell gap comprising at least one cell passage formed therebetween through which an aqueous electrolytic solution can flow, wherein the signal sensor can be activated and/or deactivated by the signal-providing composition, wherein the sensor can be located within the appliance, the signal-sensing cell, the signal-sensing device, and combinations thereof; (c) providing the aqueous electrolytic solution in fluid communication with the signal-sensing cell via tap water, wash and/or rinse liquor, and/or mixtures thereof; (d) providing at least one activator and/or deactivator in the form of the signal-providing composition comprising a signal-providing agent in the wash and/or rinse liquor; (e) optionally contacting the signal sensor with the signal-providing composition in order to activate and/or deactivate the least one signal-sensing cell, wherein the signal-sensing cell activation and/or deactivation starts or stops electrolyzed water production in the signal-sensing cell; (f) optionally contacting the signal sensor of the signal-sensing electrolytic device with the at least one signal-providing composition in order to activate a timer to delay the electrolyzed water production in the signal-sensing cell for a specific time period, wherein after the timed delay the at least one signal-sensing cell can be activated; (g) passing the aqueous electrolytic solution through at least one activated signal-sensing cell to generate at least some electrolyzed water in the wash and/or rinse liquor of the appliance; (h) contacting the tableware with the electrolyzed water in the wash and/or rinse cycle of the appliance; (i) optionally contacting the signal sensor of the electrolytic device with the signal-providing composition comprising the signal-providing agent to deactivate the at least one signal-sensing cell in order to stop production of the electrolyzed water; (j) optionally contacting the tableware with a wash and/or rinse liquor comprising a chlorine-bleach-scavenging agent or metal-protecting agent; and (k) optionally repeating steps (c) through (j) until the tableware needing treatment are treated.

Another embodiment of the present invention relates to a method further comprising steps (c) or (d) and (h).

Another embodiment of the present invention relates to a method, further comprising steps (c) or (d), and (i).

Another embodiment of the present invention relates to a method, further comprising steps (c) or (d), (h), and (i).

Another embodiment of the present invention relates to a method, further comprising steps (c) or (d), (h), (i) and (j).

Another embodiment of the present invention relates to a method, wherein after contacting the tableware with a wash and/or rinse liquor comprising a bleach-scavenging agent and/or metal-protecting agent, no further electrolyzed water comes into contact with the dishes.

Another embodiment of the present invention relates to a method, wherein the signal sensor can be activated and/or deactivated by sensing the signal-providing composition via the gaseous phase.

Another embodiment of the present invention relates to a method, wherein the signal sensor can be activated and/or deactivated by sensing the signal-providing composition via the aqueous phase.

Another embodiment of the present invention relates to a method, wherein the signal-providing composition can be selected from the group consisting of detergent compositions, rinse aid compositions, and mixtures thereof.

Another embodiment of the present invention relates to a method, wherein the signal-providing agent can be selected from the group consisting of nanoparticles, colloidal particles, functionalized surface molecules, polymers, salts, surfactants, metal ions, proteins, dyes, UV-active materials, fluorescent materials, organic acids, organic bases, inorganic acids, inorganic bases, organic solvents, builders, bleaches, bleach activators, bleach catalysts, enzymes, non-activated enzymes, enzyme stabilizing systems, chelants, optical brighteners, soil release polymers, wetting agents, dispersants, suds suppressors, gases, perfumes, colorants, filler salts, hydrotropes, photoactivators, fluorescers, hydrolyzable cosurfactants, anti-oxidants, germicides, fungicides, halide ions, color speckles, silvercare, anti-tarnish and/or anti-corrosion agents, alkalinity sources, solubilizing agents, carriers, pefumes, processing aids, pigments, and pH control agents, and mixtures thereof.

Another embodiment of the present invention relates to a method, wherein the functionalized surface molecule can comprise monomeric materials, polymers, or copolymers and mixtures thereof; wherein at least one segment or group of the monomeric material or polymer can comprise functionality that serves to provide hydrophilic or hydrophobic character to the polymer, serves to anchor or enhance adsorption on solid surfaces, or serves to provide water-affinity to the material.

Another embodiment of the present invention relates to a method, wherein the functionalized surface molecule can comprise a compound selected from the group consisting of: (a) ethoxylated oligoamines, ethoxylated and quaternized oligoamines, ethoxylated, quaternized and sulfated oligoamines, ethoxylated and sulfated oligoamines, ethoxylated oligoamines which have been converted to sulfobetaine or betaine and mixtures thereof; and (b) polycarboxylate copolymers with unsaturated monomers, including but not limited to functionalized polyacrylates, polymethacrylates, polymaleates, polyfumarates, copolymers and mixtures thereof.

Another embodiment of the present invention relates to a method, wherein the signal-providing agent can comprise at least one volatile compound.

Another embodiment of the present invention relates to a method, wherein the volatile compound can comprise a compound selected from the group consisting of volatile organic compounds, inorganic gases, and mixtures thereof.

Another embodiment of the present invention relates to a method, wherein the volatile organic compound can comprise perfumes, perfume raw materials, and mixtures thereof.

Another embodiment of the present invention relates to a method, wherein the perfume can be from about 0.01% to about 5%, by weight, a blooming perfume composition, wherein the blooming perfume composition can comprise from about 50% to about 99% of blooming perfume ingredients having a boiling point of less than about 260° C. and a C log P of at least about 3, and wherein the blooming perfume composition comprising at least about 5 different blooming perfume ingredients, and from about 0.5% to about 10% of base masking perfume ingredients having a boiling point of more than about 260° C. and a C log P of at least about 3.

Another embodiment of the present invention relates to a method, wherein the polymer can comprise a compound selected from the group consisting of poly (acrylic/allyl alcohol), poly (acrylic/maleic), poly (a-hydroxyacrylic acid), poly (tetramathylene-1,2-dicarbocylic acid), poly (4-methocy-tetramethylene-1,2-tetramethylene-1,2-dicarbocylic acid), polyacrylates, acrylic acid/maleic acid copolymers, polyalkyleneglycols, polyaminoacids, carboxyalkylcelluloses, alkylated or hydroxyalkylated celluloses, ether hydroxypolycarboxylates, polyvinylpyrrolidone, polyvinylpyridine-N-oxide, poly(vinylpyrrolidone)-co-poly(vinylimidazole), polydimethylsiloxanes, polydimethylsiloxanes, trisiloxanes with pendant polyethylene, polyethylene/polypropylene sidechains, water soluble salts, and combinations thereof.

Another embodiment of the present invention relates to a method, wherein the signal-providing agent can be a surfactant selected from the group consisting of anionic surfactants, cationic surfactants, nonionic surfactants, amphoteric surfactants, ampholytic surfactants, zwitterionic surfactants, and mixtures thereof.

Another embodiment of the present invention relates to a method, wherein the signal-providing agent can comprise a gas selected from the group consisting of oxides of nitrogen, sulfur, carbon, and mixtures thereof.

Another embodiment of the present invention relates to a method, wherein the signal-providing agent can comprise a protein selected from the group consisting of amylase, protease, lipase, peroxidase, and mixtures thereof.

Another embodiment of the present invention relates to a method, wherein the signal-providing agent can comprise a compound selected from the group consisting of dye, UV-active material, fluorescent material, and mixtures thereof.

Another embodiment of the present invention relates to a method, wherein the signal-providing agent can comprise compounds having a molecular weight less than about 1000 Da.

Another embodiment of the present invention relates to a method, wherein the signal-providing agent can comprise a metal ion and/or metal-containing species selected from the group consisting of iron, organometallic complexes of iron, manganese, organometallic complexes of manganese, cobalt, organometallic complexes of cobalt, ruthenium, organometallic complexes of ruthenium, copper organometallic complexes of copper, and mixtures thereof.

Another embodiment of the present invention relates to a method, wherein the signal-providing agent can comprise an acid selected from the group consisting of citric acid, ascorbic acid, glycolic acid, phytic acid, polycarboxylic acids, polymers and co-polymers of carboxylic acids and polycarboxylic acids, organo-diphosphonic acids and the salts thereof, ethylene diphosphonic acid, alpha-hydroxy-2 phenyl ethyl diphosphonic acid, methylene diphosphonic acid, vinylidene-1,1-diphosphonic acid, 1,2-dihydroxyethane-1,1-diphosphonic acid, hydroxy-ethane 1,1 diphosphonic acid, and mixtures thereof.

Another embodiment of the present invention relates to a method, wherein the signal-providing agent can comprise an organic solvent selected from the group consisting of low molecular weight aliphatic or aromatic alcohols, low molecular weight alkylene glycols, low molecular weight alkylene glycol ethers, low molecular weight esters, low molecular weight alkylene amines, low molecular weight alkanolamines, and mixtures thereof.

Another embodiment of the present invention relates to a method, wherein the signal-providing agent can comprise a builder and/or chelating agent selected from the group consisting of sodium tripolyphosphate, sodium pyrophosphate, EDTA, EDDS, aminophosphonates, aminocarboxylates, silicate, carboxylatephosphonates, aluminosilicates, magnesioaluminosiliates, and mixtures thereof.

Another embodiment of the present invention relates to a method, wherein the signal-providing agent can comprise OH⁻0 or H₃O⁺.

Another embodiment of the present invention relates to a method, wherein the signal-sensing cell and/or device can be selected from the group consisting of attached, integrated, unattached, self-powered, self-contained, partitioned, non-partitioned, recirculating, non-recirculating, energy-saving, disposable, non-disposable, and combinations thereof.

Another embodiment of the present invention relates to a method, wherein the bleach-scavenging agent can comprise a compound selected from the group consisting of perborate, percarbonate, ascorbic acid or derivatives thereof, carbamate, ammonium, sulfite, bisulfite, aluminum tristearate, sodium silicate, benzotriazole, amines, amino acids, and mixtures thereof.

Another embodiment of the present invention relates to a method, wherein the appliance, the signal-sensing cell, and/or device further can comprise a signal-detecting device comprising a sensor capable of analyzing the contents of the liquid and/or gaseous environment of the appliance, signal-sensing cell, and/or device for the presence of the signal-providing agent.

Another embodiment of the present invention relates to a method, wherein the sensor can be one selected from the group consisting of turbidity sensor, water hardness sensor, pH sensor, conductivity sensor, a sensor capable of detecting the presence of a volatile compound, perfume, and/or gas within the gaseous environment of the device, and combinations thereof.

Another embodiment of the present invention relates to a method, wherein the signal sensor can comprise a chemical sensor selected from the group consisting of fiber optic chemical sensor, porous polymer sensor, semiconductor chemical sensor, acoustic wave chemical sensor, optical chemical sensor, organic sensor, porous organic sensor, bio-sensor, ‘electronic nose’ sensor, ‘electronic tongue’ sensor, and combinations thereof.

Another embodiment of the present invention relates to a method, wherein the chemical sensor can comprise component selected from the group consisting of flow-through chamber, selective membrane, dialyzing membrane, ion-selective membrane, gas-permeable membrane, analyte-selective membrane, organic polymer film, metal oxide film, organometallic film, and combinations thereof.

One embodiment of the present invention relates to an article of manufacture comprising: (a) a package; (b) a replacement signal-providing detergent composition comprising a signal-providing agent selected from the group consisting of nanoparticles, colloidal particles, functionalized surface molecules, polymers, salts, surfactants, metal ions, proteins, dyes, UV-active materials, fluorescent materials, organic acids, organic bases, inorganic acids, inorganic bases, organic solvents, builders, bleaches, bleach activators, bleach catalysts, enzymes, non-activated enzymes, enzyme stabilizing systems, chelants, optical brighteners, soil release polymers, wetting agents, dispersants, suds suppressors, gases, perfumes, colorants, filler salts, hydrotropes, photoactivators, fluorescers, hydrolyzable cosurfactants, anti-oxidants, germicides, fungicides, halide ions, color speckles, silvercare, anti-tarnish and/or anti-corrosion agents, alkalinity sources, solubilizing agents, carriers, pefumes, processing aids, pigments, and pH control agents, and mixtures thereof; (c) information in association with the package comprising instructions to insert the replacement product, replacement signal-providing detergent composition, and/or the replacement a porous basket in the appliance and/or the electrolytic device.

One embodiment of the present invention relates to a composition of matter consisting essentially of the in the wash and/or rinse liquor of an automatic dishwashing appliance comprising a signal-sensing system comprising a sensor, a signal-sensing electrochemical cell and/or electrolytic device comprising the signal-sensing cell, for improved tableware cleaning, sanitizing, and/or stain removal, the composition of matter comprising: (a) at least some electrolyzed water comprising halogen-containing mixed-oxidant species; (b) a composition comprising a compound selected from the group consisting of an electrolytic composition comprising halogen ions, an electrolytic composition comprising halogen-containing salts having the formula (M)ₓ(XO₂)_{y} and/or (M)ₓ(X)_{y} wherein X can be Cl, Br, or I and wherein M can be a metal ion or cationic entity and wherein x and y are chosen such that the salt can be charge balanced, an electrolysis precursor compound, a halogen-containing salt with low water solubility, an electrolysis precursor compound contained within a medium for controlled release, and mixtures thereof; (c) a signal-providing detergent composition comprising a signal-providing agent selected from the group consisting of nanoparticles, colloidal particles, functionalized surface molecules, polymers, salts, surfactants, metal ions, proteins, dyes, UV-active materials, fluorescent materials, organic acids, organic bases, inorganic acids, inorganic bases, organic solvents, builders, bleaches, bleach activators, bleach catalysts, enzymes, non-activated enzymes, enzyme stabilizing systems, chelants, optical brighteners, soil release polymers, wetting agents, dispersants, suds suppressors, gases, perfumes, colorants, filler salts, hydrotropes, photoactivators, fluorescers, hydrolyzable cosurfactants, anti-oxidants, germicides, fungicides, halide ions, color speckles, silvercare, anti-tarnish and/or anti-corrosion agents, alkalinity sources, solubilizing agents, carriers, pefumes, processing aids, pigments, and pH control agents, and mixtures thereof; and (d) optionally, adjunct ingredient.

What is claimed is:

1. A method for cleaning tableware, comprising the steps of sequentially contacting said tableware with an aqueous cleaning liquor comprising a bleach unstable ingredient and an aqueous bleaching liquor comprising the electrolysis products of electrolytes selected from the group consisting of halide anions, halite anions, and mixtures thereof.

2. A method according to claim 1 which is conducted in an automatic dishwashing appliance, said appliance comprising an electrochemical cell and means for delivering said aqueous cleaning liquor and said aqueous bleaching liquor to said tableware in a predetermined sequence.

3. A method according to claim 1, wherein said bleach unstable ingredient in said cleaning liquor comprises a detersive enzyme selected from the group consisting of protease, amylase, and mixtures thereof.

4. A method according to claim 3, wherein said tableware is contacted with said cleaning liquor prior to contact with said bleaching liquor.

5. A method of improved cleaning, sanitizing, and/or stain removal of tableware in an automatic dishwashing appliance comprising at least one attached, integrated, signal-sensing electrochemical cell and/or at least one attached, integrated electrolytic device comprising said signal-sensing cell for producing electrolyzed water, said method comprising the steps of:
(a) placing tableware in need of treatment into said appliance;
(b) providing said signal-sensing cell comprising at least one inlet opening and one outlet opening, and at least one pair of electrodes defining at least one cell gap comprising at least one cell passage formed therebetween through which an aqueous electrolytic solution can flow;
(c) providing said aqueous electrolytic solution in said appliance in fluid communication with said signal-sensing cell and/or device;
(d) providing at least one activator and/or deactivator selected from the group consisting of timer, sensor, signal-providing chemical, signal-providing detergent composition and combinations thereof.
(e) intermittently activating said signal-sensing cell and/or device via said activator at least one specific time in the wash and/or rinse cycle;
(f) electrolyzing said aqueous electrolytic solution in said signal-sensing cell to produce at least some electrolyzed water;
(g) discharging said electrolyzed water into the wash and/or rinse liquor via a washing basin in said appliance during at least one specific time in the wash and/or rinse cycle(s);
(h) interrupting electrolyzation of said aqueous electrolytic solution and/or not releasing said electrolyzed water at other times in the wash and/or rinse cycle(s);
(i) contacting said tableware in need of treatment with said wash and/or rinse liquor comprising said electrolyzed water;
(j) intermittently deactivating said signal-sensing cell via said deactivator during at least one specific time in the wash and/or rinse cycle(s);
(k) optionally contacting said tableware with a wash and/or rinse liquor comprising a bleach-scavenging agent and/or metal-protecting agent; and
(l) optionally repeating steps (c) through (k).

6. A method according to claim 5, wherein said signal-sensing cell and/or device comprises a characteristic selected from the group consisting of attached, integrated, unattached, self-powered, self-contained, partitioned, non-partitioned, recirculating, non-recirculating, energy-saving, disposable, non-disposable, and combinations thereof.

7. A method according to claim 6, wherein said cell gap having a gap spacing between about 0.1 mm to about 5.0 mm.

8. A method according claim 6, wherein said aqueous electrolytic solution comprises salts having the formula (M)ₓ(XO₂)_{y} and/or (M)ₓ(X)_{y}, wherein X is Cl, Br, or I, wherein M is a metal ion or cationic entity, and wherein x and y are chosen such that said salt is charge balanced.

9. A method according to claim 6, wherein said sensor is capable of analyzing the composition and/or properties of the liquid or gaseous environment within said signal-sensing cell, said device and/or said appliance, and wherein said sensor can electrically and/or electronically control the production and/or discharge of said electrolyzed water at said specific time during said wash and/or rinse cycle by turning on said activator and/or said deactivator.

10. A method according to claim 9, wherein said sensor is one selected from the group consisting of turbidity sensor, water hardness sensor, pH sensor, conductivity sensor, a sensor capable of detecting the presence of a volatile gaseous compound, and combinations thereof.

11. A method according to claim 10, wherein said sensor is a pH sensor which detects the change in pH in said wash and/or rinse liquor.

12. A method according to claim 10, wherein said volatile gaseous compound is a perfume.

13. A method according to claim 6, wherein the location of said activator and/or deactivator is selected from the group consisting of said signal-sensing cell, said device, said appliance, and combinations thereof.

14. A method according to claim 13, wherein said activator and/or deactivator is located within said signal-sensing cell and/or device.

15. A method according to claim 13, wherein said activator and/or deactivator is located within said appliance.

16. A method according to claim 6, wherein prior to step (d) said method further comprises the steps of providing a detergent composition, rinse aid composition, and mixtures thereof, and delivering said composition to said wash and/or rinse liquor; wherein said composition comprises at least one signal-providing chemical.

17. A method according to claim 16, wherein said activator and/or deactivator is selected from the group consisting of chemical-based, mechanical-based, electronic-based, and combinations thereof.

18. A method according to claim 17, wherein said activator and/or said deactivator is chemical-based having the ability to detect the presence and/or absence of a signal-providing chemical in said wash and/or rinse liquors and/or their corresponding gaseous vapors via said sensor in order to activate and/or deactivate said signal-sensing cell and/or device.

19. A method according to claim 16, wherein said appliance and/or device further comprising a timer to control production of said electrolyzed water, wherein said timer is selected from the group consisting of mechanical timer, electric timer, electronic timer, and combinations thereof.

20. A method according to claim 19, wherein when said sensor detects the presence and/or absence of said signal-providing chemical in said wash and/or rinse liquor, said sensor initiates the activation of said timer such that from a certain period of time after activation of said timer said signal-sensing cell and/or device is activated and/or deactivated thereby controlling production and/or discharge of said electrolyzed water.

21. A method according to claim 17, wherein said activator and/or said deactivator is mechanical-based having the ability to turn on and off said signal-sensing cell and/or device via a variety of cycle-linked appliance performance options on said appliance which offer the consumer a combination of cleaning performance and/or sanitization.

22. A method according to claim 17, wherein said activator and/or said deactivator is electronic-based comprising a computer device that communicates with said appliance, signal-sensing cell and/or device, and combinations thereof; wherein said computer device is preprogrammed to offer consumers a means to allow said signal-sensing cell and/or device to be turned on or off during specific wash and/or rinse cycles and settings of said appliance, and wherein said computer device is selected from among the group consisting of programmable, non-programmable, and combinations thereof.

23. A method according to claim 22, wherein said appliance comprises a universal remote control device allowing communication with said electronic-based activator and/or deactivator within said appliance, signal-sensing cell and/or device; wherein said universal remote device is pre-programmed to offer consumers a means to allow said signal-sensing cell and/or device to be turned on and/or off at least one specific time during said wash and/or rinse cycle for most major brands of automatic dishwashing appliances available to the consumer.

24. A method according to claim 17, wherein said activator and/or said deactivator is electronic-based comprising a radio-transmitting device allowing communication with said appliance, signal-sensing cell, and/or device; wherein said radio-transmitting device offers consumers a means to allow said signal-sensing cell and/or device to be turned on and/or off at least one specific time during said wash and/or rinse cycle for most major brands of automatic dishwashing appliances available to the consumer.

25. A method according to claim 6, wherein prior to step (d) said method further comprises steps of providing a detergent composition comprising enzyme to said wash liquor, contacting said tableware with said enzymes for an effective period of time during at least one wash cycle; wherein during said cycle no electrolyzed water comes into contact with said enzymes.

26. A method according to claim 6, wherein said method further comprises step (k).

27. A method according to claim 28 wherein said bleach-scavenging agent and/or metal-protecting agent is selected from the group consisting of perborate, percarbonate, ascorbic acid or derivatives thereof, carbamate, ammonium, sulfite, bisulfite, aluminum tristearate, sodium silicate, benzotriazole, amines, or amino acids.

28. A method according to claim 27, wherein after contacting said tableware with a wash and/or rinse liquor comprising said bleach-scavenging agent and/or metal-protecting agent, no further electrolyzed water comes into contact with said dishes.

29. A method of improved cleaning, sanitizing, and/or stain removal of tableware in an automatic dishwashing appliance comprising a signal-sensing electrochemical cell and/or a signal-sensing an electrolytic device comprising said signal-sensing cell, said method using a signal system comprising a signal sensor, a signal-providing detergent composition in conjunction with said signal-sensing cell and/or device, said method comprising the steps of:
(a) placing tableware in need of treatment in said appliance
(b) providing a signal-sensing system; wherein said signal-sensing cell comprises at least one inlet opening and one outlet opening, and at least one pair of electrodes defining at least one cell gap comprising at least one cell passage formed therebetween through which an aqueous electrolytic solution can flow, wherein said signal sensor can be activated and/or deactivated by said signal-providing composition, wherein said sensor is located within said appliance, said signal-sensing cell, said signalsensing device, and combinations thereof;
(c) providing said aqueous electrolytic solution in fluid communication with said signalsensing cell via tap water, wash and/or rinse liquor, and/or mixtures thereof;
(d) providing at least one activator and/or deactivator in the form of said signal-providing composition comprising a signal-providing agent in said wash and/or rinse liquor;
(e) optionally contacting said signal sensor with said signal-providing composition in order to activate and/or deactivate said least one signal-sensing cell, wherein said signal-sensing cell activation and/or deactivation starts or stops electrolyzed water production in said signal-sensing cell;
(f) optionally contacting said signal sensor of said signal-sensing electrolytic device with said at least one signal-providing composition in order to activate a timer to delay said electrolyzed water production in said signal-sensing signal-sensing cell for a specific time period, wherein after said timed delay said at least one signal-sensing cell is activated;
(g) passing said aqueous electrolytic solution through at least one activated signal-sensing cell to generate at least some electrolyzed water in the wash and/or rinse liquor of said appliance;
(h) contacting said tableware with said electrolyzed water in the wash and/or rinse cycle of said appliance;
(i) optionally contacting said signal sensor of said electrolytic device with said signal-providing composition comprising said signal-providing agent to deactivate said at least one signal-sensing cell in order to stop production of said electrolyzed water;
(j) optionally contacting said tableware with a wash and/or rinse liquor comprising a chlorine-bleach-scavenging agent or metal-protecting agent; and
(k) optionally repeating steps (c) through (j) until the tableware needing treatment are treated.

30. A method according to claim 29, said method further comprising steps (c) or (d) and (h).

31. A method according to claim 29, said method further comprising steps (c) or (d), and (i).

32. A method according to claim 29, said method further comprising steps (c) or (d), (h), and (i).

33. A method according to claim 29, said method further comprising steps (c) or (d), (h), (i) and (j).

34. A method according to claim 33 wherein after contacting said tableware with a wash and/or rinse liquor comprising a bleach-scavenging agent and/or metal-protecting agent, no further electrolyzed water comes into contact with said dishes.

35. A method according to claim 29, wherein said signal sensor is activated and/or deactivated by sensing said signal-providing composition via the gaseous phase.

36. A method according to claim 29, wherein said signal sensor is activated and/or deactivated by sensing said signal-providing composition via the aqueous phase.

37. A method according to claim 29, wherein said signal-providing composition is selected from the group consisting of detergent compositions, rinse aid compositions, and mixtures thereof.

38. A method according to claim 29, wherein said signal-providing agent is selected from the group consisting of nanoparticles, colloidal particles, functionalized surface molecules, polymers, salts, surfactants, metal ions, proteins, dyes, UV-active materials, fluorescent materials, organic acids, organic bases, inorganic acids, inorganic bases, organic solvents, builders, bleaches, bleach activators, bleach catalysts, enzymes, non-activated enzymes, enzyme stabilizing systems, chelants, optical brighteners, soil release polymers, wetting agents, dispersants, suds suppressors, gases, perfumes, colorants, filler salts, hydrotropes, photoactivators, fluorescers, hydrolyzable cosurfactants, anti-oxidants, germiicides, fungicides, halide ions, color speckles, silvercare, antitarnish and/or anti-corrosion agents, alkalinity sources, solubilizing agents, carriers, pefumes, processing aids, pigments, and pH control agents, and mixtures thereof.

39. A method according to claim 38, wherein said functionalized surface molecule comprises monomeric materials, polymers, or copolymers and mixtures thereof; wherein at least one segment or group of said monomeric material or polymer comprises functionality that serves to provide hydrophilic or hydrophobic character to said polymer, serves to anchor or enhance adsorption on solid surfaces, or serves to provide water-affinity to said material.

40. A method according to claim 38, wherein said functionalized surface molecule comprises a compound selected from the group consisting of:
a) ethoxylated oligoamines, ethoxylated and quaternized oligoamines, ethoxylated, quaternized and sulfated oligoamines, ethoxylated and sulfated oligoamines, ethoxylated oligoamines which have been converted to sulfobetaine or betaine and mixtures thereof; and
b) polycarboxylate copolymers with unsaturated monomers, including but not limited to functionalized polyacrylates, polymethacrylates, polymaleates, polyfumarates, copolymers and mixtures thereof.

41. A method according to claim 29, wherein said signal-providing agent comprises at least one volatile compound.

42. A method according to claim 41, wherein said volatile compound comprises a compound selected from the group consisting of volatile organic compounds, inorganic gases, and mixtures thereof.

43. A method according to claim 42, wherein said volatile organic compound comprises perfumes, perfume raw materials, and mixtures thereof.

44. A method according to claim 43, wherein said perfume is from about 0.01% to about 5%, by weight, a blooming perfume composition, wherein said blooming perfume composition comprises from about 50% to about 99% of blooming perfume ingredients having a boiling point of less than about 260° C. and a C log P of at least about 3, and wherein said blooming perfume composition comprising at least about 5 different blooming perfume ingredients, and from about 0.5% to about 10% of base masking perfume ingredients having a boiling point of more than about 260° C. and a C log P of at least about 3.

45. A method according to claim 38, wherein said polymer comprises a compound selected from the group consisting of poly (acrylic/allyl alcohol), poly (acrylic/maleic), poly (ahydroxyacrylic acid), poly (tetramathylene-1,2-dicarbocylic acid), poly (4-methocytetramethylene-1,2-tetramethylene-1,2-dicarbocylic acid), polyacrylates, acrylic acid/maleic acid copolymers, polyalkyleneglycols, polyaminoacids, carboxyalkylcelluloses, alkylated or hydroxyalkylated celluloses, ether hydroxypolycarboxylates, polyvinylpyrrolidone, polyvinylpyridine-N-oxide, poly(vinylpyrrolidone)-co-poly(vinylimidazole), polydimethylsiloxanes, polydimethylsiloxanes, trisiloxanes with pendant polyethylene, polyethylene/polypropylene sidechains, water soluble salts, and combinations thereof.

46. A method according to claim 38, wherein said signal-providing agent is a surfactant selected from the group consisting of anionic surfactants, cationic surfactants, nonionic surfactants, amphoteric surfactants, ampholytic surfactants, zwitterionic surfactants, and mixtures thereof.

47. A method according to claim 38 wherein said signal-providing agent comprises a gas selected from the group consisting of oxides of nitrogen, sulfur, carbon, and mixtures thereof.

48. A method according to claim 38, wherein said signal-providing agent comprises a protein selected from the group consisting of amylase, protease, lipase, peroxidase, and mixtures thereof.

49. A method according to claim 38, wherein said signal-providing agent comprises a compound selected from the group consisting of dye, UV-active material, fluorescent material, and mixtures thereof.

50. A method according to claim 38, wherein said signal-providing agent comprises compounds having a molecular weight less than about 1000 Da.

51. A method according to claim 38, wherein said signal-providing agent comprises a metal ion and/or metal-containing species selected from the group consisting of iron, organometallic complexes of iron, manganese, organometallic complexes of manganese, cobalt, organometallic complexes of cobalt, ruthenium, organometallic complexes of ruthenium, copper organometallic complexes of copper, and mixtures thereof.

52. A method according to claim 38, wherein said signal-providing agent comprises an acid selected from the group consisting of citric acid, ascorbic acid, glycolic acid, phytic acid, polycarboxylic acids, polymers and co-polymers of carboxylic acids and polycarboxylic acids, organo-diphosphonic acids and the salts thereof, ethylene diphosphonic acid, alpha-hydroxy-2 phenyl ethyl diphosphonic acid, methylene diphosphonic acid, vinylidene-1,1-diphosphonic acid, 1,2-dihydroxyethane-1,1-diphosphonic acid, hydroxy-ethane 1,1 diphosphonic acid, and mixtures thereof.

53. A method according to claim 38, wherein said signal-providing agent comprises an organic solvent selected from the group consisting of low molecular weight aliphatic or aromatic alcohols, low molecular weight alkylene glycols, low molecular weight alkylene glycol ethers, low molecular weight esters, low molecular weight alkylene amines, low molecular weight alkanolamines, and mixtures thereof.

54. A method according to claim 38, wherein said signal-providing agent comprises a builder and/or chelating agent selected from the group consisting of sodium tripolyphosphate, sodium pyrophosphate, EDTA, EDDS, aminophosphonates, aminocarboxylates, silicate, carboxylatephosphonates, aluminosilicates, magnesioaluminosiliates, and mixtures thereof.

55. A method according to claim 38, wherein said signal-providing agent comprises OH⁻ or H₃O⁺.

56. A method according to claim 38 wherein said signal-sensing cell and/or device comprises a characteristic selected from the group consisting of attached, integrated, unattached, self-powered, self-contained, partitioned, non-partitioned, recirculating, non-recirculating, energy-saving, disposable, non-disposable, and combinations thereof.

57. A method according to claim 29 wherein said bleach-scavenging agent comprises a compound selected from the group consisting of perborate, percarbonate, ascorbic acid or derivatives thereof, carbamate, ammonium, sulfite, bisulfite, aluminum tristearate, sodium silicate, benzotriazole, amines, amino acids, and mixtures thereof.

58. A method according to claim 29, wherein said appliance, said signal-sensing cell, and/or device further comprises a signal-detecting device comprising a sensor capable of analyzing the contents of the liquid and/or gaseous environment of said appliance, signal-sensing cell, and/or device for the presence of said signal-providing agent.

59. A method according to claim 29, wherein said sensor is one selected from the group consisting of turbidity sensor, water hardness sensor, pH sensor, conductivity sensor, a sensor capable of detecting the presence of a volatile compound, perfume, and/or gas within the gaseous environment of said device, and combinations thereof.

60. A method according to claim 29, wherein said signal sensor comprises a chemical sensor selected from the group consisting of fiber optic chemical sensor, porous polymer sensor, semiconductor chemical sensor, acoustic wave chemical sensor, optical chemical sensor, organic sensor, porous organic sensor, bio-sensor, ‘electronic nose’ sensor, ‘electronic tongue’ sensor, and combinations thereof.

61. A method according to claim 60, wherein said chemical sensor comprises component selected from the group consisting of flow-through chamber, selective membrane, dialyzing membrane, ion-selective membrane, gas-permeable membrane, analyte-selective membrane, organic polymer film, metal oxide film, organometallic film, and combinations thereof.

62 An article of manufacture comprising:
(a) a package;
(b) a replacement signal-providing detergent composition comprising a signal-providing agent selected from the group consisting of nanoparticles, colloidal particles, functionalized surface molecules, polymers, salts, surfactants, metal ions, proteins, dyes, UV-active materials, fluorescent materials, organic acids, organic bases, inorganic acids, inorganic bases, organic solvents, builders, bleaches, bleach activators, bleach catalysts, enzymes, non-activated enzymes, enzyme stabilizing systems, chelants, optical brighteners, soil release polymers, wetting agents, dispersants, suds suppressors, gases, perfumes, colorants, filler salts, hydrotropes, photoactivators, fluorescers, hydrolyzable cosurfactants, anti-oxidants, germicides, fungicides, halide ions, color speckles, silvercare, anti-tarnish and/or anti-corrosion agents, alkalinity sources, solubilizing agents, carriers, pefumes, processing aids, pigments, and pH control agents, and mixtures thereof
(c) information in association with said package comprising instructions to insert said replacement product, replacement signal-providing detergent composition, and/or said replacement a porous basket in said appliance and/or said electrolytic device.

63. A composition of matter consisting essentially of the in the wash and/or rinse liquor of an automatic dishwashing appliance comprising a signal-sensing system comprising a sensor, a signal-sensing electrochemical cell and/or electrolytic device comprising said signal-sensing cell, for improved tableware cleaning, sanitizing, and/or stain removal, said composition of matter comprising:
(a) at least some electrolyzed water comprising halogen-containing mixed-oxidant species;
(b) a composition comprising a compound selected from the group consisting of an electrolytic composition comprising halogen ions, an electrolytic composition comprising halogen-containing salts having the formula (M)ₓ(XO₂)_{y} and/or (M)ₓ(X)_{y} wherein X is Cl, Br, or I and wherein M is a metal ion or cationic entity and wherein x and y are chosen such that the salt is charge balanced, an electrolysis precursor compound, a halogen-containing salt with low water solubility, an electrolysis precursor compound contained within a medium for controlled release, and mixtures thereof;
(c) a signal-providing detergent composition comprising a signal-providing agent selected from the group consisting of nanoparticles, colloidal particles, functionalized surface molecules, polymers, salts, surfactants, metal ions, proteins, dyes, UV-active materials, fluorescent materials, organic acids, organic bases, inorganic acids, inorganic bases, organic solvents, builders, bleaches, bleach activators, bleach catalysts, enzymes, non-activated enzymes, enzyme stabilizing systems, chelants, optical brighteners, soil release polymers, wetting agents, dispersants, suds suppressors, gases, perfumes, colorants, filler salts, hydrotropes, photoactivators, fluorescers, hydrolyzable cosurfactants, anti-oxidants, germicides, fungicides, halide ions, color speckles, silvercare, anti-tarnish and/or anti-corrosion agents, alkalinity sources, solubilizing agents, carriers, pefumes, processing aids, pigments, and pH control agents, and mixtures thereof; and
(d) optionally, adjunct ingredient.

64. A method according to claim 5, wherein said activator and/or deactivator comprises a signal sensor that can electrically and/or electronically activate and/or deactivate the production of electrolyzed water in said signal-sensing cell.

65. A method according to claim 64, wherein said sensor is capable of analyzing or detecting the composition of the fluid or gaseous environment in said device and/or within said appliance, and wherein said sensor can signal said device and/or said cell causing said device and/or said cell to activate or deactivate said cell.

66. A method according to claim 5, wherein said activator and/or deactivator comprises a timer to electrically and/or mechanically activate and/or deactivate the production of electrolyzed water in said signal-sensing cell.
